(19) United States
(12) Patent Application Publication
(10) Pub. No.: US 2026/0215404 A1
(43) Pub. Date: Jul. 30, 2026

(54) FISHING LINE GUIDE AND FISHING ROD INCLUDING FISHING LINE GUIDE

(71) Applicant: FUJI KOGYO CO., LTD., Shizuoka-shi (JP)

(72) Inventor: Kazuhito OMURA, Shizuoka-shi (JP)

(73) Assignee: FUJI KOGYO CO., LTD., Shizuoka-shi (JP)

(21) Appl. No.: 19/422,536

(22) Filed: Dec. 17, 2025

(30) Foreign Application Priority Data
Jan. 24, 2025 (KR) 10-2025-0011094
Oct. 20, 2025 (KR) 10-2025-0151451

(51) Int. Cl. A01K 87/04

(52) U.S. Cl. CPC A01K 87/04

(57) ABSTRACT

A fishing line guide and a fishing rod including the fishing line guide are provided. A pair of lower legs of the fishing line guide extend downward from a ring holding portion of the fishing line guide, and have a bent-shaped cross section. A pair of lateral legs of the fishing line guide are connected to the ring holding portion above a center of the ring holding portion, and have a rectangular-shaped cross section. A front outer contour line of the lower leg is tangent to a middle of an outer peripheral surface of the ring holding portion. When the fishing line guide is viewed from a top view, an intersection point of a pair of imaginary extension lines respectively passing through outward long sides of the rectangular-shaped cross section of the pair of lateral legs is positioned within an attachment foot.

### CROSS-REFERENCE TO RELATED APPLICATION

This application is based upon and claims the benefit of priority from Korean Patent Application No. 10-2025-0011094, filed on January 24, 2025, and Korean Patent Application No. 10-2025-0151451, filed on October 20, 2025, the entire contents of which are incorporated herein by reference.

### TECHNICAL FIELD

The present disclosure relates to a fishing line guide guiding a fishing line, and to a fishing rod including a fishing line guide.

### BACKGROUND

In fishing using a reel, a fishing line is wound around the reel and is reeled out from the reel. A fishing rig including a fishing hook is coupled to a leading end of the fishing line. A fishing line guide that guides the fishing line is attached to a rod pipe of a fishing rod. When an angler casts the fishing rig, the fishing line, reeled out from the reel, is guided along the rod pipe to a tip of the fishing rod by the fishing line guide. When the angler manipulates the reel to reel in a fish, the fishing line is guided along the rod pipe to the reel by the fishing line guide.

The fishing line guide consists of a guide ring through which the fishing line passes, and a metallic structure that supports the guide ring and is attached to the rod pipe. The aforesaid metallic structure has a ring holding portion holding the guide ring, a support leg extending from the ring holding portion, and an attachment foot that extends from the support leg and makes contact with the rod pipe.

When the angler casts the fishing rig, the fishing line may not move in a straight line along the rod pipe and can become slack. A portion of the slack fishing line can be caught on the ring holding portion or the support leg, and the fishing line can become tangled at the ring holding portion, the support leg, or a portion between the ring holding portion and the support leg. Accordingly, the fishing line guide is required to be designed to untangle a line tangle of the fishing line and to achieve smooth movement of the fishing line.

As one example of the fishing line guide according to a prior art technique, there is known a fishing line guide that has two pairs of support legs formed symmetrically back and forth. Such a fishing line guide has a stepped portion causing the fishing line to be caught thereon, and is not designed to untangle a line tangle of the fishing line. In addition, the support legs of such a fishing line guide can often come into contact with the fishing line that is spirally reeled out from a spinning reel.

As another example of the fishing line guide according to a prior art technique, there is known a fishing line guide that has one central support leg and a pair of inclined support legs. Such a fishing line guide must be attached to the rod pipe only in a specific attachment direction depending on types of the reels employed in the fishing rod. The fishing line guide that is designed such that the pair of inclined support legs are directed toward the reel cannot untangle the line tangle of the fishing line in case where it is attached to the rod pipe such that the pair of inclined support legs are directed toward a tip of the fishing rod. The fishing line guide that is designed such that the pair of inclined support legs are directed toward the tip of the fishing rod can avoid the contact between the pair of inclined support legs and the spiral fishing line reeled out from the spinning reel, but cannot untangle various types of line tangles of the fishing line.

The aforementioned fishing line guide according to a prior art technique having one central support leg and a pair of inclined support legs has restriction on the attachment direction to the rod pipe. Thus, such fishing line guide does not satisfy preferences of anglers who desire double-sided use of the fishing line guide. Further, such fishing line guide can untangle only limited types of line tangles because of its application only in one attachment direction, and cannot untangle various types of line tangles.

### SUMMARY

Disclosed embodiments provide a fishing line guide that solves at least one or more of the aforementioned problems of the prior art technique. One embodiment of the present disclosure provides a fishing line guide that does not have a restriction on an attachment direction to a rod pipe of a fishing rod and can untangle a line tangle of a fishing line. One embodiment of the present disclosure provides a fishing line guide that can cope with a fishing line reeled out in a spiral shape and can untangle various types of line tangles of a fishing line.

Disclosed embodiments relate to a fishing line guide attached to a rod pipe of a fishing rod, and to a fishing rod including such a fishing line guide. One aspect of the disclosed embodiments relates to a fishing line guide that has two attachment feet making contact with the rod pipe, and another aspect of the disclosed embodiments relates to a fishing line guide that has one attachment foot making contact with the rod pipe.

The fishing line guide according to one embodiment comprises a guide ring, a ring holding portion, a pair of lower legs, a pair of lateral legs, a first attachment foot extending from the pair of lower legs, and a second attachment foot extending from the pair of lateral legs. The guide ring is configured such that a fishing line passes through the guide ring. The ring holding portion is formed in an annular shape. The ring holding portion has an outer peripheral surface, an inner peripheral surface coupled to the guide ring, and an annular end surface formed between the outer peripheral surface and the inner peripheral surface and oriented in a tip direction or a butt direction of the fishing rod. The pair of lower legs extend downward from the ring holding portion to approach each other. The pair of lower legs have a bent-shaped cross section that is formed in a shape of a bent band when taken in a sectioning direction parallel to a central axis of the rod pipe. The pair of lateral legs are connected to the ring holding portion above a position where the pair of lower legs are connected to the ring holding portion. The pair of lateral legs extend from the ring holding portion downward and in an orientation direction of the annular end surface, and arcuately bend to approach each other. The pair of lateral legs have a rectangular-shaped cross section that is formed in a rectangular shape when taken in a traversing direction orthogonal to an outermost surface. In a front view in which the fishing line guide is viewed in an opposite direction of the orientation direction of the annular end surface, each of the pair of lower legs has a front outer contour line, and the front outer contour line is tangent to a middle of the outer peripheral surface. In a rear view in which the fishing line guide is viewed in the orientation direction of the annular end surface, each of the pair of lateral legs has a rear outer contour line, and the rear outer contour line arcuately bends to have an inflection point positioned outside the outer peripheral surface and is connected to the outer peripheral surface. In a top view of the fishing line guide, the pair of lateral legs arcuately bend such that an intersection point of a pair of imaginary extension lines respectively passing through outward long sides of the rectangular-shaped cross section of the pair of lateral legs is positioned within the second attachment foot.

In one embodiment, each of the pair of lower legs includes a bent outward surface that is arcuately bent by an arcuately bent outward side of the bent-shaped cross section, and each of the lateral legs includes an outward long-sided surface that includes the outward long side of the rectangular-shaped cross section. The bent outward surface of the lower leg forms the front outer contour line and is continuously connected to the outer peripheral surface to cause the fishing line to move to the outer peripheral surface of the ring holding portion. The outward long-sided surface of the lateral leg forms the rear outer contour line and is continuously connected to the outer peripheral surface to cause the fishing line to move to the outer peripheral surface of the ring holding portion.

In one embodiment, in the rear view of the fishing line guide, the pair of lateral legs arcuately bend such that the intersection point of the rectangular-shaped cross section is positioned between a position above an upper end of the outer peripheral surface and a position of an upper surface of the second attachment foot at an imaginary vertical axis passing through a center of the ring holding portion. Further, in a side view of the fishing line guide, each of the pair of lateral legs arcuately bends to have an upper contour line formed only by the outward long-sided surface.

In one embodiment, in the side view of the fishing line guide, the pair of lower legs extend from the ring holding portion such that the outer peripheral surface has a side outer contour line perpendicular with respect to a lower end contour line of the first attachment foot, and that the pair of lower legs are inclined in the opposite direction of the orientation direction of the annular end surface with respect to the side outer contour line.

In one embodiment, the first attachment foot includes a pair of lower end edges formed in a longitudinal direction of the first attachment foot, and a concave lower surface formed between the pair of lower end edges. Each of the pair of lower legs includes a bent inward surface that is angularly bent by an angularly bent inward side of the bent-shaped cross section. The bent inward surface has an angularly bent edge that is continuously connected to one of the pair of lower end edges.

In one embodiment, the fishing line guide further comprises a bridging portion that is formed integrally with the pair of lateral legs and the second attachment foot at lower ends of the pair of lateral legs and a base end of the second attachment foot. The second attachment foot includes a pair of lower end edges formed in a longitudinal direction of the second attachment foot, and a concave lower surface formed between the pair of lower end edges. The bridging portion has a pair of angularly bent edges that become boundaries between the pair of lateral legs and the bridging portion and are continuously connected to the pair of lower end edges, respectively.

In one embodiment, in the rear view of the fishing line guide, the pair of lateral legs are connected to the ring holding portion such that the ring holding portion is positioned inside an imaginary semicircle. One end of the imaginary semicircle is positioned at an upper intersection point between one of the pair of the lateral legs and the annular end surface, and an opposite end of the imaginary semicircle is positioned at a lateral intersection point between the other of the pair of lateral legs and an imaginary horizontal line passing through a lower end of a passage hole of the guide ring.

In one embodiment, in the front view and the rear view of the fishing line guide, the pair of lower legs extend from the ring holding portion such that the front outer contour line is positioned between a first imaginary contour line and a second imaginary contour line that correspond to the rear outer contour line. The first imaginary contour line has a first horizontal spaced distance between the first imaginary contour line and an imaginary vertical axis passing through the center of the ring holding portion, and the second imaginary contour line has a second horizontal spaced distance between the second imaginary contour line and the imaginary vertical axis. The first horizontal spaced distance is equal to 80% of a referential horizontal spaced distance between the imaginary vertical axis and the rear outer contour line, and the second horizontal spaced distance is equal to 105% of the referential horizontal spaced distance.

In one embodiment, each of the pair of lateral legs has a bent band-shaped cross section that is formed in a shape of a bent band when taken in the traversing direction at the vicinity of the second attachment foot, and the rectangular-shaped cross section between the bent band-shaped cross section and the ring holding portion. Each of the pair of lateral legs is formed such that a cross section of each of the pair of lateral legs gradually changes from the bent band-shaped cross section to the rectangular-shaped cross section from the second attachment foot toward the annular end surface of the ring holding portion.

The fishing line guide according to another embodiment comprises a guide ring, a ring holding portion, a pair of lower legs, an attachment foot, and a bridging portion.

The guide ring is configured such that a fishing line passes through the guide ring. The ring holding portion is formed in an annular shape. The ring holding portion has an outer peripheral surface, an inner peripheral surface coupled to the guide ring, and an annular end surface formed between the outer peripheral surface and the inner peripheral surface and oriented in a tip direction of the fishing rod. The pair of lower legs extend downward from the ring holding portion to approach each other. The pair of lower legs have a bent-shaped cross section that is formed in a shape of a bent band when taken in a sectioning direction parallel to a central axis of the rod pipe. The attachment foot extends from the pair of lower legs. The bridging portion is formed integrally with the pair of lower legs and the attachment foot at lower ends of the pair of lower legs and a base end of the attachment foot. In a front view in which the fishing line guide is viewed in an opposite direction of an orientation direction of the annular end surface, each of the pair of lower legs has a front outer contour line that is tangent to a middle of the outer peripheral surface. Each of the pair of lower legs includes a bent outward surface, which is arcuately bent by an arcuately bent outward side of the bent-shaped cross section and forms the front outer contour line. The bent outward surface is continuously connected to the outer peripheral surface to cause the fishing line to move to the outer peripheral surface of the ring holding portion. In a side view of the fishing line guide, the pair of lower legs extend from the ring holding portion such that the outer peripheral surface of the ring holding portion has a side outer contour line perpendicular with respect to a lower end contour line of the attachment foot, and that the pair of lower legs are inclined in the opposite direction of the orientation direction of the annular end surface with respect to the side outer contour line.

Further, the disclosed embodiments relate to a fishing rod including the fishing line guide. The fishing rod according to one embodiment includes a rod pipe, and the fishing line guide according to the above-described embodiments that is attached to the rod pipe.

The fishing line guide according to one embodiment can untangle the line tangle of the fishing line both in an attachment direction in which the pair of lateral legs face the tip of the fishing rod and in an attachment direction in which the pair of lateral legs face a reel. Accordingly, the fishing line guide according to one embodiment does not have restriction on the attachment direction to the rod pipe, and can easily untangle the line tangle of the fishing line.

The fishing line guide according to one embodiment can cope with the fishing line reeled out in a spiral shape, and can untangle various types of line tangles of the fishing line.

The fishing line guide according to one embodiment has the bridging portion formed between the pair of lower legs and the first attachment foot, and the bridging portion formed between the pair of lateral legs and the second attachment foot. Therefore, the fishing line guide according to one embodiment can prevent deformation caused due to high-load tension of the tangled fishing line, and can have improved strength.

### BRIEF DESCRIPTION OF DRAWINGS

The accompanying drawings, which are incorporated in and constitute a part of the specification, illustrate embodiments of the present disclosure, and together with the general description given above and the detailed description of the embodiments given below, serve to explain the principles of the present disclosure.

FIG. 1 is a side view showing one example of a fishing rod that includes a fishing line guide according to one embodiment.

FIG. 2 is a side view showing another example of a fishing rod that includes a fishing line guide according to one embodiment.

FIG. 3 is a side view showing a fishing line guide according to one embodiment.

FIG. 4 is a front view of the fishing line guide shown in FIG. 3.

FIG. 5 is a rear view of the fishing line guide shown in FIG. 3.

FIG. 6 is a partial top view of the fishing line guide shown in FIG. 3, showing a cross-sectional shape of a lower leg and a cross-sectional shape of a lateral leg as viewed from above.

FIG. 7 is a perspective view showing a fishing line guide according to one embodiment, where a lateral leg is disposed to face in a tip direction of a fishing rod.

FIG. 8 is another perspective view showing a fishing line guide according to one embodiment, where a lateral leg is disposed to face in a tip direction of a fishing rod.

FIG. 9 is a partial bottom view of the fishing line guide shown in FIG. 3, showing a lower surface of an attachment foot.

FIG. 10 is a side view of a fishing line guide according to one embodiment, showing a rectangular-shaped cross section of a lateral leg.

FIG. 11 is a top view of a fishing line guide according to one embodiment, showing a rectangular-shaped cross section of a lateral leg.

FIG. 12 is a rear view of a fishing line guide according to one embodiment, showing a rectangular-shaped cross section of a lateral leg.

FIG. 13 is a perspective view of a fishing line guide according to one embodiment, showing a rectangular-shaped cross section of a lateral leg.

FIG. 14 is another perspective view of a fishing line guide according to one embodiment, showing a rectangular-shaped cross section of a lateral leg.

FIG. 15 is a front view of a fishing line guide according to one embodiment, where depiction of a lateral leg is omitted.

FIG. 16 is a perspective view showing an example where a fishing line guide according to one embodiment is disposed by normal attachment.

FIG. 17 is a perspective view showing an example where a fishing line guide according to one embodiment is disposed by reverse attachment.

FIG. 18 is a perspective view showing an example where a fishing line becomes tangled when a fishing line guide according to one embodiment is disposed by normal attachment.

FIG. 19 is a perspective view showing an example where a line tangle of the fishing line shown in FIG. 18 occurs and the line tangle is untangled.

FIG. 20 is a view showing a front view and a side view of the fishing line guide shown in FIG. 19 and the fishing line shown in FIG. 19.

FIG. 21 is a top view of the fishing line guide shown in FIG. 19, showing a cross section of a lower leg and a cross section of a lateral leg.

FIG. 22 is a perspective view showing an example where the line tangle of the fishing line shown in FIG. 19 and FIG. 20 is untangled.

FIG. 23 is a perspective view showing an example where a fishing line becomes tangled when a fishing line guide according to one embodiment is disposed by reverse attachment.

FIG. 24 is a perspective view showing an example where a line tangle of the fishing line shown in FIG. 23 occurs and the line tangle is untangled.

FIG. 25 is a view showing a rear view and a side view of the fishing line guide shown in FIG. 24 and the fishing line shown in FIG. 24.

FIG. 26 is a top view of the fishing line guide shown in FIG. 24, showing a cross section of a lower leg and a cross section of a lateral leg.

FIG. 27 is a perspective view showing an example where the line tangle of the fishing line shown in FIG. 24 is untangled.

FIG. 28 is a view showing a rear view and a side view of the fishing line guide shown in FIG. 27 and the fishing line shown in FIG. 27.

FIG. 29 is a side view showing a fishing line guide according to a modified embodiment.

FIG. 30 is a top view of the fishing line guide shown in FIG. 29.

FIG. 31 is a perspective view showing the fishing line guide shown in FIG. 29, where a lateral leg is disposed to face in a tip direction of a fishing rod.

FIG. 32 is another perspective view showing the fishing line guide shown in FIG. 29, where a lateral leg is disposed to face in a tip direction of a fishing rod.

FIG. 33 is a perspective view showing a fishing line guide according to another embodiment

FIG. 34 is a front view of the fishing line guide shown in FIG. 33.

FIG. 35 is a partial top view of the fishing line guide shown in FIG. 33, showing a cross section of a lower leg.

FIG. 36 is another perspective view of the fishing line guide shown in FIG. 33.

FIG. 37 is a side view of the fishing line guide shown in FIG. 33.

FIG. 38 is a partial bottom view of the fishing line guide shown in FIG. 33, showing a lower surface of an attachment foot.

### DETAILED DESCRIPTION

Embodiments of the present disclosure are illustrated for the purpose of explaining the technical idea of the present disclosure. The scope of the rights according to the present disclosure is not limited to the embodiments presented below or the detailed descriptions of such embodiments.

All technical terms and scientific terms used in the present disclosure include meanings that are commonly understood by those of ordinary skill in the technical field to which the present disclosure pertains unless otherwise defined. All terms used in the present disclosure are selected for the purpose of describing the present disclosure more clearly, and are not selected to limit the scope of the rights according to the present disclosure.

Expressions such as "comprising," "including," "having," and the like used in the present disclosure are to be understood as open-ended terms having the possibility of encompassing other embodiments, unless otherwise stated in the phrase or sentence containing such expressions.

Singular expressions described in the present disclosure may encompass meanings of a plural form unless otherwise stated, which will also apply to singular expressions recited in the claims.

Expressions such as "first," "second," etc. used in the present disclosure are used to distinguish a plurality of elements from one another, and are not intended to limit an order or importance of the elements.

In the present disclosure, the description that one element is "connected" or "coupled" to another element should be understood to indicate that the aforesaid one element may be directly connected or coupled to the aforesaid another element, and should be further understood that the aforesaid one element may be connected or coupled to the aforesaid another element via a new element.

Dimensional and numerical values described in the present disclosure are not limited only to the dimensional and numerical values that are described herein. Unless specified otherwise, the dimensional and numerical values may be understood to mean the described values and equivalent ranges including the values.

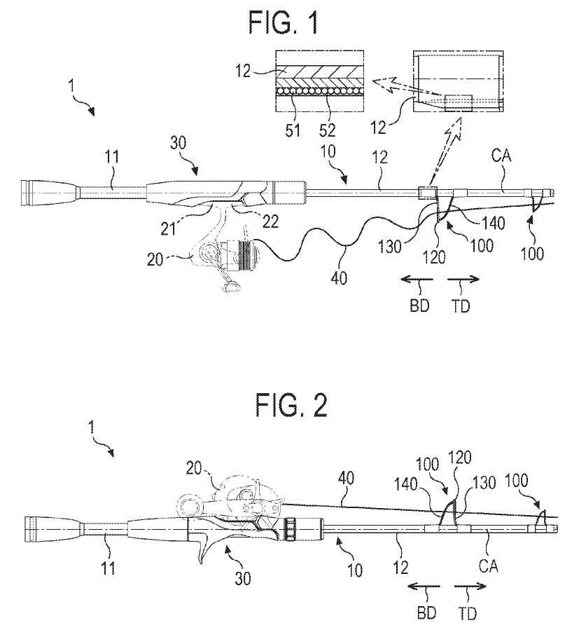

In the present disclosure, a tip direction means a direction directed toward a tip of a fishing rod, while a butt direction means a direction opposite to the tip direction and directed toward a butt of a fishing rod. For instance, in FIG. 1 and FIG. 2, a tip direction TD is a direction directed toward a tip of a fishing rod with reference to a fishing line guide, and a butt direction BD is a direction directed toward a butt of a fishing rod and a reel with reference to a fishing line guide. The tip direction may correspond to a forward direction of a fishing rod, and the butt direction may correspond to a rearward direction of a fishing rod. In the present disclosure, the directional term "upward" is based on a direction in which a guide ring of a fishing line guide is positioned with respect to a rod pipe of the fishing rod, and the directional term "downward" means a direction opposite to the upward direction.

In the present disclosure, the term "contour line" means a line that is seen at the outermost end of an element of a fishing line guide or forms the outermost edge of an element of the fishing line guide when the fishing line guide is viewed in any one direction. For instance, a front outer contour line means a line that forms the outermost end of an element in a front view of the fishing line guide, and a rear outer contour line means a line that forms the outermost end of an element in a rear view of the fishing line guide. Further, a side outer contour line means a line that forms the leftmost end or the rightmost end of an element in a side view of the fishing line guide.

Hereinafter, embodiments are described with reference to the accompanying drawings. Like reference symbols in the accompanying drawings denote like or corresponding elements. Further, in the following descriptions of the embodiments, redundant descriptions for the same or corresponding elements may be omitted. However, even if the descriptions of the elements are omitted, such elements are not intended to be excluded in any embodiment.

Reference is made to FIG. 1 that shows a fishing rod according to one embodiment of the present disclosure. The fishing rod 1 includes a rod pipe 10, and a fishing line guide 100 according to one embodiment of the present disclosure that is attached to the rod pipe.

The rod pipe 10 functions as a main body of the fishing rod, and is capable of bending resiliently during fishing. The rod pipe 10 has a shape of a thin and long pipe. The fishing rod may include a single rod pipe or a plurality of rod pipes. The rod pipe 10 of the fishing rod 1 shown in FIG. 1 includes a first rod pipe 11 and a second rod pipe 12. The first rod pipe 11 constitutes a butt portion of the fishing rod. A tip end portion of the second rod pipe 12 constitutes a tip portion of the fishing rod. The second rod pipe 12 may include a single rod pipe or two or more rod pipes having different diameters.

A fishing line 40 and a reel 20, around which the fishing line is wound, may be employed in the fishing rod. A fishing rig having a fishing hook may be coupled to a leading end of the fishing line 40. When an angler casts the fishing rig, the fishing line 40 is reeled out from the reel 20 in the tip direction TD of the fishing rod. As the angler manipulates the reel 20 to reel in a fish, the fishing line 40 is moved in the butt direction BD of the fishing rod and is wound around the reel 20.

The fishing rod 1 shown in FIG. 1 employs the reel 20 that is disposed below a central axis CA of the rod pipe. The reel 20 depicted in FIG. 1 may be referred to as a spinning reel. The reel 20 has a spool around which the fishing line 40 is wound, and the spool of the reel 20 rotates about a rotation shaft that is approximately parallel to the central axis CA of the rod pipe. Thus, when the fishing line 40 is reeled out from the reel 20, a portion of the fishing line 40 adjacent to the reel 20 may take a spiral shape.

The fishing rod 1 may include a reel seat 30 for fixing and supporting the reel 20. The reel seat 30 releasably fixes, at its underside, two attachment legs 21 and 22 of the reel 20, connecting the reel 20 to the rod pipe 10. The reel seat 30 is coupled to the rod pipe 10. By way of example, the first rod pipe 11 and the second rod pipe 12 are inserted into the reel seat 30 and are bonded to the reel seat 30, thereby coupling the reel seat 30 and the rod pipe 10. The angler can manipulate the reel 20 with one hand in a state where the angler grips the reel seat 30 with the other hand.

The fishing rod 1 includes the fishing line guide 100 according to one embodiment of the present disclosure that is attached to the rod pipe 10 to guide the fishing line 40. The fishing line guide 100 guides the fishing line that is reeled out from the reel 20 when casting the fishing rig, or is wound around the reel 20 when reeling in a fish. As shown in FIG. 1, a plurality of fishing line guides 100 that have the same configuration and different sizes may be attached to the rod pipe (e.g., the second rod pipe 12), and may be disposed along the rod pipe.

The fishing line guide 100 may be firmly fixed to the rod pipe 10 by means of an attachment foot and a fixing thread 51. For instance, the attachment foot is firmly fixed to the rod pipe 12 by bringing the attachment foot into contact with an outer surface of the rod pipe 12 and then densely winding the fixing thread 51 around both the attachment foot and a portion of the rod pipe 12 where the attachment foot is located. After the fixing thread 51 is wound, an adhesive is applied on the fixing thread 51 that is wound. If the applied adhesive is cured, then an adhesive coating 52 is formed on the fixing thread 51 that is wound. The adhesive coating 52 can prevent unwinding of the fixing thread.

Reference is made to FIG. 2 that shows a fishing rod according to another embodiment. The fishing rod 1 shown in FIG. 2 employs the reel 20 disposed above the central axis CA of the rod pipe, and the reel seat 30 releasably fixes, at its top side, two attachment legs of the reel 20. The reel 20 depicted in FIG. 2 may be referred to as a double axis reel. The spool of the reel 20, around which the fishing line 40 is wound, is disposed orthogonally to the central axis CA of the rod pipe. To guide the fishing line 40 reeled out from the reel 20, the fishing line guide 100 is attached to the rod pipe 10 in an attachment direction different from an attachment direction of the fishing line guide shown in FIG. 1. The fishing line guide shown in FIG. 1 can be used as the fishing line guide shown in FIG. 2 by being reversed up and down and front and rear.

The fishing line guide 100 according to one embodiment shown in FIG. 1 and FIG. 2 includes a ring holding portion 120, a lower leg 130 extending from the ring holding portion 120, and a lateral leg 140 extending from the ring holding portion 120. In the fishing rod shown in FIG. 1, the fishing line guide 100 is attached to the rod pipe such that the lateral leg 140 faces in the tip direction TD. Hereinafter, where the fishing line guide is attached to the rod pipe as shown in FIG. 1, the attachment of the fishing line guide is referred to as normal attachment. In the fishing rod shown in FIG. 2, the fishing line guide 100 is attached to the rod pipe such that the lateral leg 140 faces in the butt direction BD. Hereinafter, where the fishing line guide is attached to the rod pipe as shown in FIG. 2, the attachment of the fishing line guide is referred to as reverse attachment.

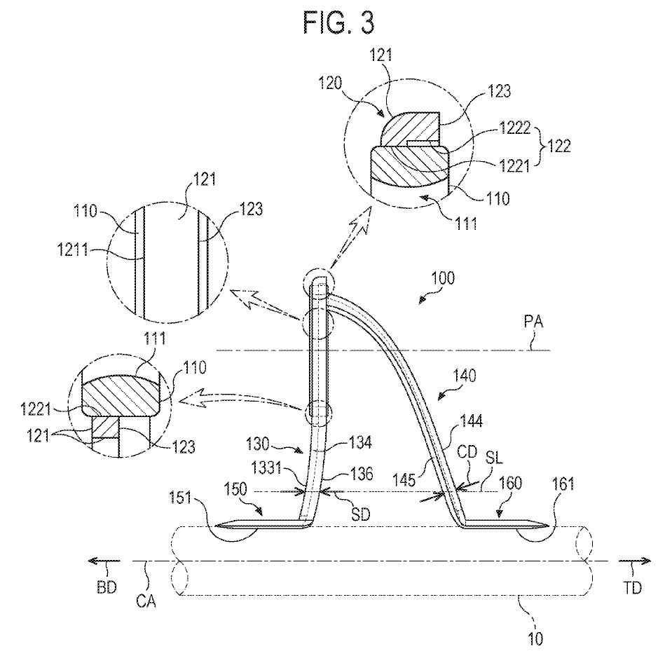

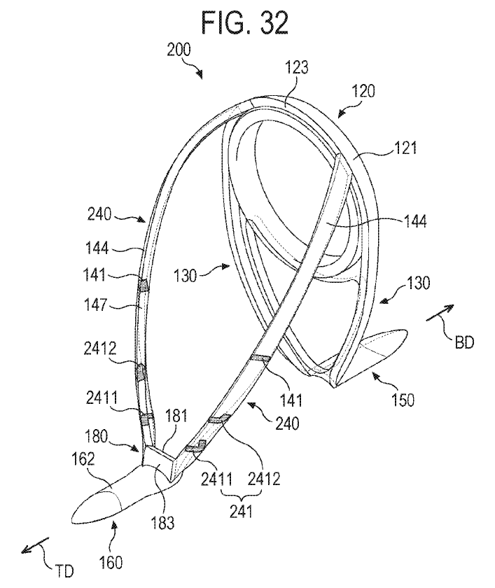

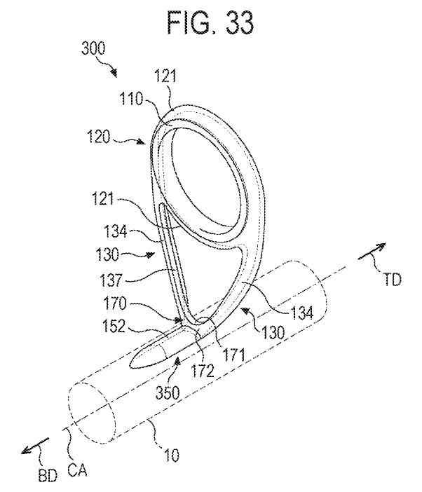

FIGS. 3 to 38 show various embodiments of the fishing line guide. The fishing line guide shown in FIGS. 3 to 32 includes two attachment feet making contact with the rod pipe of the fishing rod, while the fishing line guide shown in FIGS. 33 to 38 includes one attachment foot making contact with the rod pipe of the fishing rod. With regard to the aforementioned attachment direction of the fishing line guide, FIGS. 3 to 15 and FIGS. 29 to 32 show the fishing line guide that is disposed by the normal attachment.

Referring to FIGS. 3 to 5, the fishing line guide 100 according one embodiment includes a guide ring 110, a ring holding portion 120, a pair of lower legs 130, a pair of lateral legs 140, a first attachment foot 150, and a second attachment foot 160.

The guide ring 110 is formed in a ring shape. The guide ring 110 is configured such that a fishing line (e.g., the fishing line 40 shown in FIGS. 1 and 2) passes through the guide ring. An inner peripheral surface of the guide ring 110 forms a passage hole 111 through which the fishing line passes. The fishing line can come into contact with a surface of the passage hole 111. The guide ring 110 may be made of a ceramic material having wear resistance, and may be coupled to the ring holding portion 120 through fitting and bonding.

The ring holding portion 120, the lower legs 130, the lateral legs 140, the first attachment foot 150, and the second attachment foot 160 are made of a metallic material and are formed integrally. By way of example, a metallic sheet that is made of a metallic material such as stainless steel, titanium, or brass may be prepared. A blank that has a shape formed by spreading the fishing line guide 100 to a development figure may be obtained from the metallic sheet by press-working the metallic sheet (e.g., blanking working). A workpiece, in which the ring holding portion, the lower legs, the lateral legs, the first attachment foot, and the second attachment foot are integrally formed, may be formed by press-working the blank (e.g., drawing working, bending working). After such a workpiece is formed, the guide ring 110 may be coupled to the ring holding portion 120.

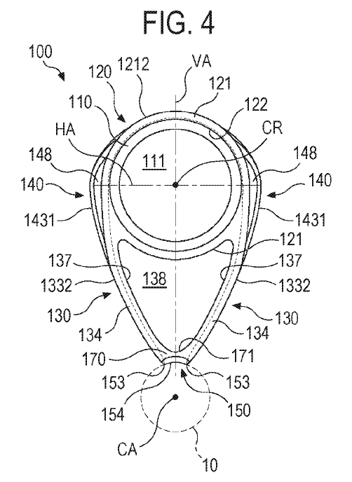

The fishing line guide 100 is formed to have bilateral symmetry. When assuming an imaginary vertical axis VA that passes through a center CR of the ring holding portion 120 and is orthogonal to the central axis CA of the rod pipe (e.g., see FIG. 4), each element of the fishing line guide is formed to be bilateral symmetrical or mirror symmetrical with reference to the imaginary vertical axis VA. The pair of lower legs 130 are formed symmetrically with reference to the imaginary vertical axis VA, and the pair of lateral legs 140 are formed symmetrically with reference to the imaginary vertical axis VA.

The ring holding portion 120 is formed in an annular shape to hold the guide ring 110. Referring to FIG. 3, the ring holding portion 120 formed in an annular shape has an outer peripheral surface 121, an inner peripheral surface 122, and an annular end surface 123. The outer peripheral surface 121 is the outermost surface of the ring holding portion, and the inner peripheral surface 122 is the innermost surface of the ring holding portion. The annular end surface 123 is formed between the outer peripheral surface 121 and the inner peripheral surface 122.

The inner peripheral surface 122 is coupled to an outer peripheral surface of the guide ring 110. The guide ring 110 may be coupled to the ring holding portion by being fitted to the inner peripheral surface 122 of the ring holding portion. The guide ring 110 may be firmly fixed to the ring holding portion 120 by means of an adhesive that is applied between the outer peripheral surface of the guide ring and the inner peripheral surface 122 of the ring holding portion. The inner peripheral surface 122 may have a fitting surface 1221 formed in an annular shape, and a concave surface 1222 formed along a circumference of the fitting surface 1221. The guide ring 110 may be coupled to the fitting surface 1221. The fitting surface 1221 may form a through hole of the ring holding portion 120 to which the guide ring is coupled.

The outer peripheral surface 121 is formed in an annular shape, and includes a bent surface. The outer peripheral surface 121 meets with the inner peripheral surface 122 at its edge in the butt direction BD. The annular end surface 123 is located between an edge of the outer peripheral surface 121 in the tip direction TD and an edge of the inner peripheral surface 122 in the tip direction TD, and is formed in an annular shape. The annular end surface 123 extends in a circumferential direction of the ring holding portion 120 between the outer peripheral surface 121 and the inner peripheral surface 122, and interconnects the outer peripheral surface 121 and the inner peripheral surface 122. The annular end surface 123 includes a flat surface.

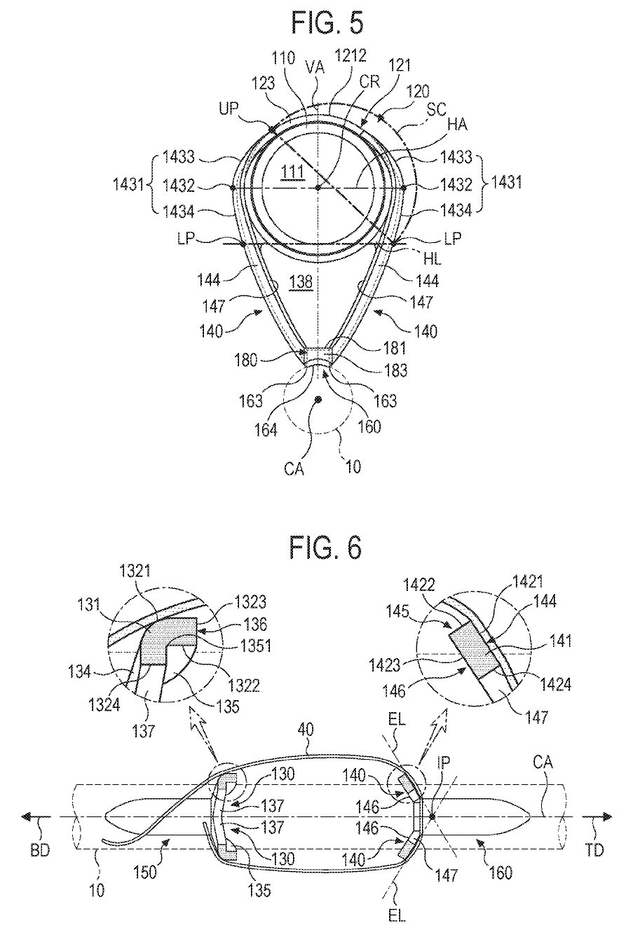

In the fishing line guide according to one embodiment, the annular end surface 123 is oriented in the tip direction TD of the fishing rod or in the butt direction BD of the fishing rod. Where the fishing line guide is disposed on the rod pipe by the normal attachment (see FIG. 1), the annular end surface 123 is oriented in the tip direction of the fishing rod, and an orientation direction of the annular end surface becomes the tip direction. Where the fishing line guide is disposed on the rod pipe by the reverse attachment (see FIG. 2), the annular end surface 123 is oriented in the butt direction of the fishing rod, and the orientation direction of the annular end surface becomes the butt direction. In this regard, FIG. 4 shows a front view of the fishing line guide that is viewed in the opposite direction of the orientation direction of the annular end surface, and FIG. 5 shows a rear view of the fishing line guide that is viewed in the orientation direction of the annular end surface 123.

The pair of lower legs 130 are formed integrally with the ring holding portion 120, and support the ring holding portion 120. Each of the pair of lower legs 130 is connected to the ring holding portion 120 below the center CR of the ring holding portion. An uppermost end of each lower leg may be positioned at an imaginary horizontal axis HA that passes through the center CR of the ring holding portion and is orthogonal to the imaginary vertical axis VA, or may be positioned below the imaginary horizontal axis HA.

In the front view of the fishing line guide shown in FIG. 4, the pair of lower legs 130 extend downward from the ring holding portion 120 to approach each other, and lower ends of the lower legs 130 approaching each other are connected to the first attachment foot 150. The imaginary vertical axis VA is located between the pair of lower legs 130, and the pair of lower legs 130 are spaced apart from the imaginary vertical axis VA at an equal distance.

The pair of lateral legs 140 are formed integrally with the ring holding portion 120, and support the ring holding portion 120. Each of the pair of lateral legs 140 is connected to the ring holding portion 120 above a position where the pair of the lower legs 130 are connected to the ring holding portion 120. Each of the pair of lateral legs 140 is connected to the ring holding portion 120 above the center CR of the ring holding portion. A lowermost end of a connection portion between each lateral leg and the ring holding portion is positioned above the imaginary horizontal axis HA. In the side view of the fishing line guide (see FIG. 3) and the rear view of the fishing line guide (see FIG. 5), the pair of the lateral legs 140 extend from the ring holding portion 120 downward and in the orientation direction of the annular end surface 123 (i.e., in the tip direction in case of the normal attachment), and arcuately bend to approach each other. Where the annular end surface 123 faces in the tip direction, the pair of lateral legs 140 extend downward and forward (in the tip direction) from the ring holding portion 120. Lower ends of the lateral legs 140 approaching each other are connected to the second attachment foot 160. In the rear view of the fishing line guide (FIG. 5), the imaginary vertical axis VA is located between the pair of lateral legs 140, and the pair of lateral legs 140 are spaced apart from the imaginary vertical axis VA at an equal distance. In the front view and the rear view of the fishing line guide, each of the lateral legs 140 extends from the ring holding portion 120 such that a space is not formed between the lateral leg and the lower leg.

The first attachment foot 150 and the second attachment foot 160 function as a portion that couples fishing line guide to the rod pipe. The first attachment foot 150 and the second attachment foot 160 are configured to make contact with the rod pipe 10 of the fishing rod (e.g., the second rod pipe 12 shown in FIG. 1 and FIG. 2). The fishing line guide may be attached to the rod pipe by bringing the first attachment foot 150 and the second attachment foot 160 into contact with an outer surface of the rod pipe and fixing the respective attachment feet to the rod pipe by the aforementioned fixing thread.

The first attachment foot 150 angularly bends and extends from the pair of lower legs 130. The first attachment foot 150 is formed integrally with the lower ends of the pair of lower legs 130, and has a base end that is connected to the lower ends of the lower legs. The first attachment foot 150 extends from the lower ends of the pair of lower legs 130 in the opposite direction of the orientation direction of the annular end surface 123 (i.e., in the butt direction in case of the normal attachment). For instance, in the normal attachment of the fishing line guide shown in FIG. 3, the first attachment foot 150 extends in the butt direction BD. The second attachment foot 160 angularly bends and extends from the pair of lateral legs 140. The second attachment foot 160 is formed integrally with the lower ends of the pair of lateral legs 140, and has a base end that is connected to the lower ends of the lateral legs. The second attachment foot 160 extends from the lower ends of the pair of lateral legs 140 in the orientation direction of the annular end surface 123 (i.e., in the tip direction in case of the normal attachment). The first attachment foot 150 and the second attachment foot 160 may be formed to have the same size, the same thickness, and the same length, but the second attachment foot may have a size greater than that of the first attachment foot depending on the embodiment of the fishing line guide. The lower legs and the lateral legs may be connected to the ring holding portion such that a vertical distance between the first attachment foot 150 and an imaginary parallel axis PA passing through the center CR of the ring holding portion and parallel to the central axis CA of the rod pipe, and a vertical distance between the second attachment foot 160 and the imaginary parallel axis PA are equal.

According to one embodiment of the fishing line guide, the pair of lower legs 130 extend from the ring holding portion 120 such that the ring holding portion 120 and the first attachment foot 150 are disposed at a right angle. In the side view of the fishing line guide (see FIG. 3), the outer peripheral surface 121 has a side outer contour line 1211 that is perpendicular with respect to a lower end contour line 151 of the first attachment foot and a lower end contour line 161 of the second attachment foot, and the pair of lower legs 130 are inclined in the opposite direction of the orientation direction of the annular end surface 123 with respect to the side outer contour line 1211 of the outer peripheral surface of the ring holding portion. For instance, in case of the normal attachment (see FIG. 3), the pair of lower legs 130 are inclined in the butt direction BD with respect to the side outer contour line 1211 of the ring holding portion (the side outer contour line of the outer peripheral surface positioned in the opposite direction of the orientation direction of the annular end surface). In the side view of the fishing line guide, the lower leg 130 has a side outer contour line 1331. The side outer contour line 1331 of the lower leg may be defined between the imaginary parallel axis PA and an upper surface of the first attachment foot 150. The side outer contour line 1331 of the lower leg is continuously connected to the side outer contour line 1211 of the ring holding portion, and is inclined from the side outer contour line 1211 of the ring holding portion in the opposite direction of the orientation direction of the annular end surface 123. Since the lower leg 130 is inclined with respect to the side outer contour line 1211 of the ring holding portion, the fishing line can be moved from the lower leg 130 to the outer peripheral surface 121 of the ring holding portion.

When the fishing line becomes tangled with the fishing line guide during casting of the fishing rig, the fishing line guide can easily untangle the line tangle of the fishing line. The lower legs and the lateral legs that have a specific sectional shape and are connected to the ring holding portion at a specific position can achieve disentanglement of the line tangle.

According to one embodiment of the fishing line guide, each of the pair of lower legs 130 has an upper end that is positioned at the middle of the outer peripheral surface 121 of the ring holding portion in a vertical direction (e.g., a point of the outer peripheral surface meeting with the imaginary horizontal axis HA). In the front view of the fishing line guide (see FIG. 4), each of the pair of lower legs 130 has a front outer contour line 1332 that is defined between the upper end positioned at the middle of the outer peripheral surface 121 of the ring holding portion and a lateral end of the first attachment foot 150. Each of the lower legs 130 is connected to the ring holding portion 120 such that the front outer contour line 1332 is tangent to the outer peripheral surface 121 of the ring holding portion at the upper end of each of the lower legs 130. Therefore, two front outer contour lines 1332 of the pair of lower legs 130 have a maximum spaced distance at the middle of the outer peripheral surface 121 of the ring holding portion, and have a minimum spaced distance at the lateral end of the first attachment foot 150.

Reference is made to FIGS. 3, 4, and 6. FIG. 6 shows a cross-sectional shape of the lower leg 130 as viewed from above. As one example of the cross-sectional shape of the lower leg, the cross-sectional shape of the lower leg 130 at the position of an imaginary sectioning line SL shown in FIG. 3 is shown in FIG. 6, and the imaginary sectioning line SL is parallel to the central axis CA of the rod pipe.

Each of the pair of lower legs 130 has a bent-shaped cross section 131 when taken in a sectioning direction SD that is parallel to the central axis CA of the rod pipe (see FIG. 3). The pair of lower legs 130 may have the bent-shaped cross section 131 between the ring holding portion 120 and the base end of the first attachment foot 150. The bent-shaped cross section 131 may be formed in a shape of a bent band. In the top view of the fishing line guide or in the cross-sectional view of the lower leg that is taken in the sectioning direction, the aforesaid bent-band shape bends to be concave with respect to the central axis CA of the rod pipe. By way of example, the bent-shaped cross section 131 may be formed in an L-like shape, a C-like shape or a circular arc shape. Thus, in the top view of the fishing line guide or in the cross-sectional view of the lower leg taken in the sectioning direction, each of the lower legs 130 has the bent-shaped cross section 131 that bends to be concave with respect to the central axis of the rod pipe.

The bent-shaped cross section 131 that is formed in a shape of a bent band is defined by four sides. Referring to FIG. 6, the aforesaid four sides include an outward side 1321, an inward side 1322, an outer end side 1323, and an inner end side 1324. In the top view of the fishing line guide or the cross-sectional view of the lower leg, the outward side 1321 faces in an outward direction away from the central axis CA of the rod pipe (an outward direction of the lower leg). The inward side 1322 is located opposite to the outward side 1321, and faces in an inward direction toward the central axis CA of the rod pipe (an inward direction of the lower leg) in the top view of the fishing line guide or the cross-sectional view of the lower leg. The outer end side 1323 interconnects the outward side 1321 and the inward side 1322, and faces in the orientation direction of the annular end surface (the tip direction in case of the normal attachment and the butt direction in case of the reverse attachment). The inner end side 1324 interconnects the outward side 1321 and the inward side 1322, and faces in the inward direction toward the central axis of the rod pipe in the top view of the fishing line guide or the cross-sectional view of the lower leg. The outward side 1321 has an arcuately bent shape without angulated portions. The inward side 1322 may have an arcuately bent shape like the outward side 1321. According to one embodiment, the inward side 1322 has an angularly bent shape so as to have an angulated portion.

Since the bent-shaped cross section 131 is formed by the aforesaid four sides, each lower leg includes four surfaces that correspond to the aforesaid four sides, respectively. Each lower leg includes a bent outward surface 134 including the outward side 1321, a bent inward surface 135 including the inward side 1322, an outer end surface 136 including the outer end side 1323, and an inner end surface 137 including the inner end side 1324.

The bent outward surface 134 is arcuately bent by the outward side 1321. The bent outward surface 134 forms the outermost surface of the lower leg. The bent outward surface 134 is arcuately bent, and the fishing line 40 comes into contact with the bent outward surface 134 along the bent outward surface 134 in a large range. The bent inward surface 135 is angularly bent by the inward side 1322. The bent inward surface 135 is located opposite to the bent outward surface 134, and is connected to the inner peripheral surface of the ring holding portion. The outer end surface 136 and the inner end surface 137 are formed as a flat surface. The outer end surface 136 is continuously connected to the annular end surface of the ring holding portion, and is continuously connected to the base end and the lower end of the first attachment foot 150. The inner end surface 137 is continuously connected to a lower portion of the outer peripheral surface 121 of the ring holding portion.

Referring to FIG. 4, an outer edge of the bent outward surface 134 of the lower leg forms the front outer contour line 1332. The bent outward surface 134 is continuously connected to the outer peripheral surface 121 of the ring holding portion, and is connected to the upper surface of the first attachment foot 150. The bent outward surface 134 is configured to cause the fishing line to slide to the outer peripheral surface 121 of the ring holding portion 120 when a line tangle of the fishing line occurs. Thus, the bent outward surface 134 moves the fishing line to the outer peripheral surface 121 of the ring holding portion, and therefore can untangle the line tangle.

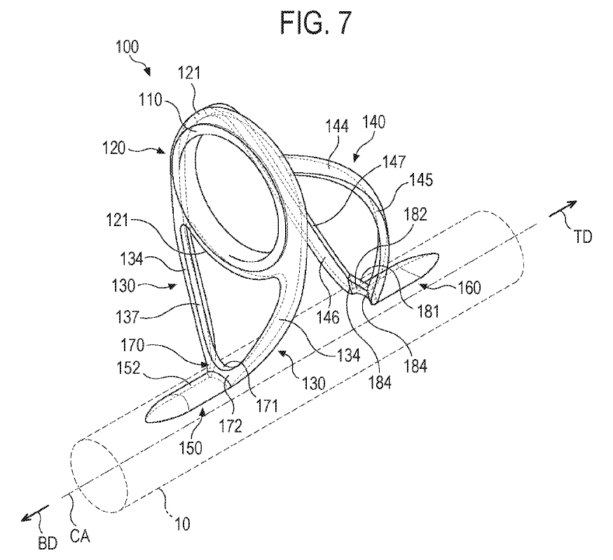

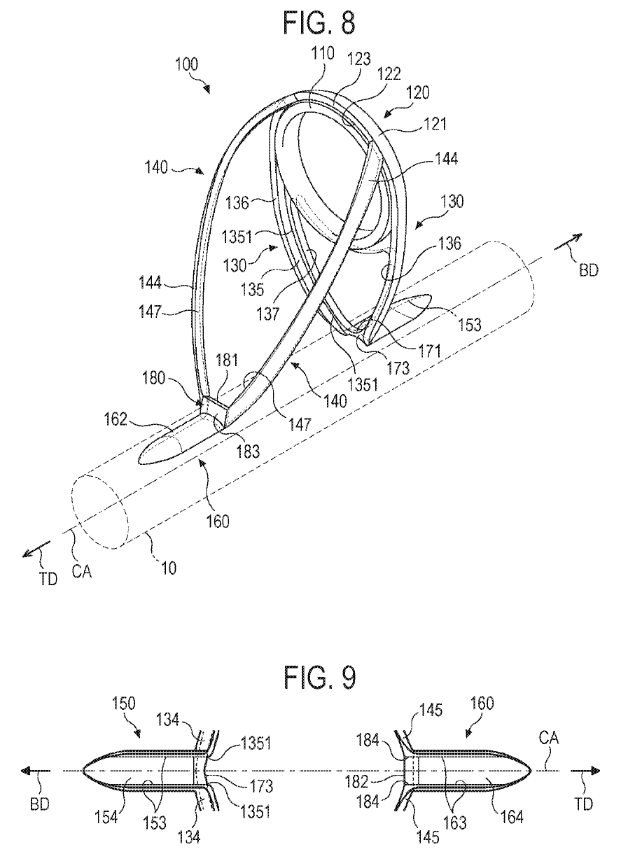

Reference is made to FIG. 4 together with FIGS. 7 and 8 showing perspective views of the fishing line guide. FIG. 8 reversely shows the tip direction in case of the normal attachment shown in FIG. 7. According to one embodiment of the fishing line guide, the fishing line guide 100 includes a bridging portion 170 that is formed at the lower ends of the pair of lower legs 130 and the base end of the first attachment foot 150. The bridging portion 170 is formed integrally with the pair of lower legs 130 and the first attachment foot 150, and can improve the strength of a connection portion of the lower legs and the first attachment foot.

The bent outward surface 134, the bent inward surface 135, and the inner end surface 137 of each lower leg are continuously connected to the bridging portion 170. The bridging portion 170 includes an upward end surface 171 that is continuously connected to the inner end surface 137 of each lower leg. The outer peripheral surface 121 of the ring holding portion, the inner end surface 137 of each lower leg, and the upward end surface 171 of the bridging portion form an opening 138 between the pair of lower legs. The bridging portion 170 includes an outward end surface 172 that is connected to the upper surface 152 of the first attachment foot 150. The outward end surface 172 faces in the tip direction (in case of the normal attachment) or in the butt direction (in case of the reverse attachment) depending on the attachment direction of the fishing line guide. The outward end surface 172 of the bridging portion angularly bends with respect to the upper surface 152 of the first attachment foot 150. The bridging portion 170 includes an inward end surface 173 that is continuously connected to the bent inward surface 135 of each lower leg. The inward end surface 173 is located opposite to the outward end surface 172.

Reference is made to FIGS. 3 to 5. According to one embodiment of the fishing line guide, above the center CR of the ring holding portion, each of the pair of lateral legs 140 is connected to the outer peripheral surface 121, the inner peripheral surface 122, and the annular end surface 123 of the ring holding portion.

In the rear view (FIG. 5) of the fishing line guide, each of the pair of lateral legs 140 arcuately bends to bulge outward of the outer peripheral surface 121 of the ring holding portion and then to approach each other, and is connected to the second attachment foot 160. Each of the pair of lateral legs 140 has a rear outer contour line 1431 that is defined between the outer peripheral surface 121 of the ring holding portion and the lower end of the second attachment foot 160. The rear outer contour line 1431 is connected to the outer peripheral surface 121 of the ring holding portion and the lower end of the second attachment foot 160. The rear outer contour line 1431 is defined between the lower end of the second attachment foot 160 and an intersection point of each lateral leg and the outer peripheral surface of the ring holding portion.

The rear outer contour line 1431 arcuately bends to have an inflection point 1432 that is positioned outside the outer peripheral surface 121 of the ring holding portion. Each lateral leg extending from the ring holding portion has an inflection portion 148 formed at the position of the inflection point 1432, and extends from the inflection portion 148 toward the second attachment foot 160. In the rear view (FIG. 5) of the fishing line guide, the inflection point 1432 may be positioned at the imaginary horizontal axis HA. Thus, the rear outer contour line 1431 of each lateral leg includes a first rear outer contour line 1433 located above the inflection point 1432, and a second rear outer contour line 1434 located below the inflection point 1432. The first rear outer contour line 1433 bulges further outward than an outer peripheral contour line 1212 of the outer peripheral surface 121 of the ring holding portion. The second rear outer contour line 1434 extends from a lower end of the first rear outer contour line 1433 to the lower end of the second attachment foot 160. Two rear outer contour lines 1431 of the pair of lateral legs 140 have a maximum spaced distance between the respective inflection points 1432, and have a minimum spaced distance at the lower end of the second attachment foot 160.

The pair of lateral legs 140 are connected to the ring holding portion 120 such that the tangled fishing line moves easily along the ring holding portion 120. Referring to FIG. 5, the pair of lateral legs 140 are connected to the ring holding portion 120 such that the ring holding portion 120 is positioned inside an imaginary semicircle SC, thus causing the tangled fishing line to smoothly slide along the ring holding portion 120. One end of the imaginary semicircle SC is positioned at an upper intersection point UP between one of the pair of the lateral legs 140 and the annular end surface 123 of the ring holding portion. The opposite end of the imaginary semicircle SC is positioned at a lateral intersection point LP between the other of the pair of lateral legs 140 and an imaginary horizontal line HL passing through a lower end of the passage hole 111 of the guide ring 110 and parallel to the imaginary horizontal axis HA. Each lateral leg is connected to the ring holding portion 120 such that the ring holding portion 120 is positioned inside the imaginary semicircle SC having the upper intersection point UP and the lateral intersection point LP as its both end points.

Reference is made to FIGS. 3, 5, and 6. FIG. 6 is a partial top view of the fishing line guide, and shows a cross section of the lateral leg at the position of the imaginary sectioning line SL of FIG. 3.

Each of the pair of lateral legs 140 has a rectangular-shaped cross section 141 that is formed in a rectangular shape when taken in a traversing direction CD (see FIG. 3) of each lateral leg. The traversing direction CD is a direction that traverses each lateral leg so as to be orthogonal to the outermost surface of each lateral leg. Each lateral leg may have the rectangular-shaped cross section 141 between the ring holding portion 120 and the base end of the second attachment foot 160. Since each lateral leg arcuately bends from the ring holding portion toward the second attachment foot, an angle formed by the central axis of the rod pipe and the traversing direction CD can vary along the outermost surface of the lateral leg. As one example of the rectangular-shaped cross section of the lateral leg, the rectangular-shaped cross section 141 taken in the traversing direction CD at the position of the imaginary sectioning line SL of FIG. 3 is shown in FIG. 6.

The rectangular-shaped cross section 141 is defined by four sides, and the aforesaid four sides have a shape of a straight line. The aforesaid four sides include an outward long side 1421, an outward short side 1422, an inward long side 1423, and an inward short side 1424.

Each lateral leg arcuately bends such that, in the top view of the fishing line guide or the cross-sectional view of the lateral leg taken in the traversing direction CD, the outward long side 1421 and the outward short side 1422 face in the outward direction away from the central axis CA of the rod pipe (an outward direction of the lateral leg), and the inward long side 1423 and the inward short side 1424 face in the inward direction toward the central axis CA of the rod pipe (an inward direction of the lateral leg). The inward long side 1423 is located opposite to the outward long side 1421. The outward short side 1422 interconnects the outward long side 1421 and the inward long side 1423, and the inward short side 1424 interconnects the outward long side 1421 and the inward long side 1423. In the top view of the fishing line guide or the cross-sectional view of the lateral leg, the pair of lateral legs 140 extend and arcuately bend from the ring holding portion such that an intersection point IP of a pair of imaginary extension lines EL respectively passing through the outward long sides 1421 of the rectangular-shaped cross section 141 of the pair of lateral legs is positioned within the second attachment foot 160 and at the central axis CA of the rod pipe.

Since the rectangular-shaped cross section 141 of each lateral leg is formed by the four sides, each lateral leg includes four flat surfaces. Referring together to FIGS. 6 to 8, each lateral leg includes an outward long-sided surface 144 including the outward long side 1421, an inward long-sided surface 146 including the inward long side 1423, an outward short-sided surface 145 including the outward short side 1422, and an inward short-sided surface 147 including the inward short side 1424. The outward long-sided surface 144 is formed by the outward long side 1421 of the rectangular-shaped cross section. The outward long-sided surface 144 becomes the outermost surface of the lateral leg. Since the pair of lateral legs 140 arcuately bend such that the intersection point IP of the imaginary extension lines EL from the outward long sides 1421 of the outward long-sided surface 144 is positioned within the second attachment foot 160, the fishing line 40 can come into contact with the outward long-sided surface 144 having a large width, instead of coming into contact with a boundary between the outward long-sided surface and the outward short-sided surface. The outward long-sided surface 144 is connected to the outer peripheral surface 121 of the ring holding portion. The inward long-sided surface 146 is located opposite to the outward long-sided surface 144, and is connected to the inner peripheral surface 122 of the ring holding portion. The outward short-sided surface 145 and the inward short-sided surface 147 are connected to the annular end surface 123 of the ring holding portion.

Referring to FIG. 5, an outer edge of the outward long-sided surface 144 of the lateral leg forms the rear outer contour line 1431 of the lateral leg. The outward long-sided surface 144 is continuously connected to the outer peripheral surface 121 of the ring holding portion, and is connected to the lower end of the second attachment foot 160. The outward long-sided surface 144 is configured to cause the fishing line to slide to the outer peripheral surface 121 of the ring holding portion when the line tangle of the fishing line occurs. When the line tangle of the fishing line occurs, the outward long-sided surface 144 moves the fishing line to the outer peripheral surface 121 of the ring holding portion, and thus can untangle the line tangle.

Reference is made to FIGS. 5, 7, and 8. According to one embodiment of the fishing line guide, the fishing line guide 100 includes a bridging portion 180 that is formed at the lower ends of the pair of lateral legs 140 and the base end of the second attachment foot 160. The bridging portion 180 is formed integrally with the pair of lateral legs 140 and the second attachment foot 160, and can improve the strength of a connection portion of the lateral legs and the second attachment foot.

The outward long-sided surface 144, the inward long-sided surface 146, and the inward short-sided surface 147 of each lateral leg are connected to the bridging portion 180. The bridging portion 180 includes an upward end surface 181 that is connected to the inward short-sided surface 147 of each lateral leg. The bridging portion 180 includes an inward end surface 182 that is connected to the inward long-sided surface 146 of each lateral leg. The bridging portion 180 includes an outward end surface 183 that is connected to the upper surface 162 of the second attachment foot 160 and the outward long-sided surface 144 of each lateral leg. The outward end surface 183 of the bridging portion 180 angularly bends with respect to the upper surface 162 of the second attachment foot.

According to one embodiment of the fishing line guide, the fishing line guide has improved strength between the first attachment foot and the lower legs, and has improved strength between the second attachment foot and the lateral legs. An angularly bent edge provided between the attachment foot and the leg can improve the strength between the attachment foot and the leg.

Referring to FIG. 4, together with FIG. 9 showing a partial bottom view of the fishing line guide, the first attachment foot 150 includes a pair of lower end edges 153 and a concave lower surface 154 formed therebetween. The pair of lower end edges 153 can make contact with the rod pipe of the fishing rod, and can form the above-described lower end contour line of the first attachment foot. The pair of lower end edges 153 are formed in a longitudinal direction of the first attachment foot 150, and may be parallel to the central axis CA of the rod pipe. The concave lower surface 154 is defined by the pair of lower end edges 153, and is roundly concave.

Referring to FIGS. 8 and 9, the pair of lower end edges 153 are connected to the bent inward surfaces 135 of the pair of lower legs 130, respectively. An angularly bent edge 1351 of each of the bent inward surfaces 135 is continuously connected to one of the pair of lower end edges 153. The angularly bent edge 1351 corresponds to an angularly bent point of the inward side of the bent-shaped cross section. The inward end surface 173 of the bridging portion 170 is continuously connected to the concave lower surface 154, and the outer end surface 136 of each lower leg is connected to one of the pair of lower end edges 153.

Press lines that are formed in the fishing line guide manufactured by the press working form the pair of lower end edges 153 and the angularly bent edges 1351 each connected to the lower end edge. The press line may mean an angularly bent linear portion or an angularly bent edge that is created in the press-worked metallic sheet. Since each lower end edge and each angularly bent edge, which are formed by the press lines, are connected continuously, the fishing line guide can have improved strength between the lower legs and the first attachment foot.

Referring to FIGS. 5 and 9, the second attachment foot 160 includes a pair of lower end edges 163 and a concave lower surface 164 formed therebetween. The pair of lower end edges 163 can make contact with the rod pipe of the fishing rod, and can form the above-described lower end contour line of the second attachment foot. The pair of lower end edges 163 are formed in a longitudinal direction of the second attachment foot 160, and may be parallel to the central axis CA of the rod pipe. The concave lower surface 164 is defined by the pair of lower end edges 163, and is roundly concave.

Referring to FIGS. 7 and 9, the bridging portion 180 includes a pair of angularly bent edges 184 that are continuously connected to the pair of lower end edges 163, respectively. The pair of angularly bent edges 184 of the bridging portion become boundaries between the pair of lateral legs 140 and the bridging portion 180. Further, the inward end surface 182 of the bridging portion is continuously connected to the concave lower surface 164, and the outward short-sided surface 145 of each lateral leg is connected to one of the pair of lower end edges 163. Press lines of the fishing line guide manufactured by the press working form the pair of lower end edges 163 and the angularly bent edges 184 each connected to the lower end edge. Since each lower end edge of the second attachment foot and each angularly bent edge of the bridging portion are connected continuously, the fishing line guide can have improved strength between the lateral legs and the second attachment foot.

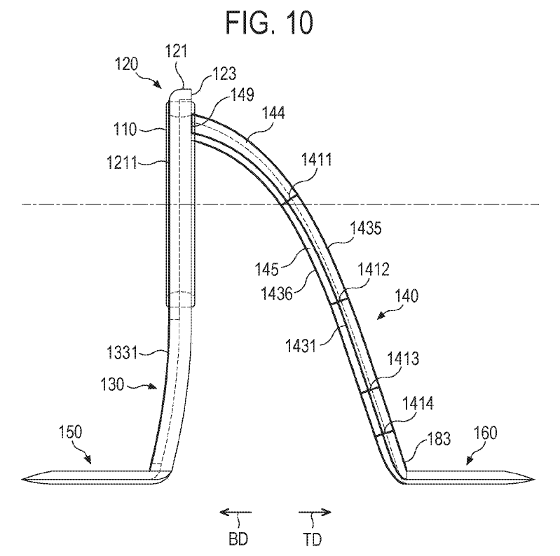

FIGS. 10 to 14 show the rectangular-shaped cross section of the lateral leg in detail. Hereinafter, the rectangular-shaped cross section of the lateral leg and the arcuately bent structure of the lateral leg are described with reference to FIGS. 10 to 14.

Referring to FIG. 10 that shows the side view of the fishing line guide, each lateral leg 140 has an upper contour line 1435 and a lower contour line 1436. The upper contour line 1435 is defined between an intersection point of the outward long-sided surface 144 and the annular end surface 123 and an intersection point of the outward long-sided surface 144 and the second attachment foot 160. The lower contour line 1436 is defined between an intersection point of the outward short-sided surface 145 and the annular end surface 123 and an intersection point of the outward short-sided surface 145 and the second attachment foot 160. Each lateral leg 140 arcuately bends to have the upper contour line 1435 formed only by the outward long-sided surface 144. Each lateral leg 140 arcuately bends to have the lower contour line 1436 formed only by the outward short-sided surface 145. Therefore, in the side view of the fishing line guide according to one embodiment, only the outward long-sided surface 144 and the outward short-sided surface 145 of each lateral leg are observed, and the inward long-sided surface and the inward short-sided surface of each lateral leg are not observed. Further, the outward long-sided surface 144 extends from the outer peripheral surface 121 of the ring holding portion to the outward end surface 183 of the bridging portion with almost no twisting, causing the fishing line to smoothly slide along the outward long-sided surface 144. For instance, each lateral leg extends from the ring holding portion such that the outward long-sided surface 144 and the inward long-sided surface are not inverted with respect to each other, and therefore, a surface area of the outward long-sided surface 144 making contact with the fishing line can be maximized.

FIGS. 10 to 14 illustrate the rectangular-shaped cross section of each lateral leg 140 and a connection section of the lateral leg and the ring holding portion. For example, FIG. 10 illustrates four rectangular-shaped cross sections (first to fourth rectangular-shaped cross sections 1411, 1412, 1413, and 1414) of the lateral leg and the connection section 149, and shows the first to fourth rectangular-shaped cross sections and the connection section by a grey area. As noted above, the rectangular-shaped cross section of the lateral leg is taken in the traversing direction that traverses the lateral leg to be orthogonal to the outermost surface of the lateral leg. The outermost surface of the lateral leg may be the outward long-sided surface 144, and each of the rectangular-shaped cross sections 1411, 1412, 1413, and 1414 may be orthogonal to the outward long-sided surface 144. Since each lateral leg arcuately bends, the angles formed by the rectangular-shaped cross sections of each lateral leg and the central axis of the rod pipe can be different from one another. The connection section 149 of each lateral leg is a section between each lateral leg and the annular end surface of the ring holding portion, and may be perpendicular to the central axis of the rod pipe.

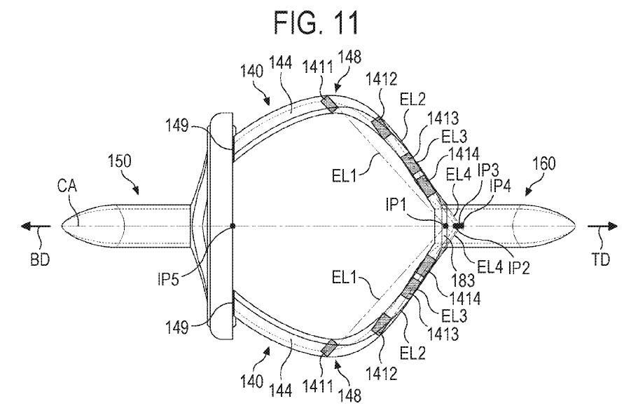

Referring to FIG. 11 that shows the top view of the fishing line guide, the first rectangular-shaped cross section 1411 is located near the inflection portion 148, and an intersection point IP1 of imaginary extension lines EL1 passing respectively through the outward long sides of the first rectangular-shaped cross section 1411 is positioned at the central axis CA of the rod pipe within the base end of the second attachment foot 160 or the outward end surface 183 of the bridging portion. The fourth rectangular-shaped cross section 1414 is located near the base end of the second attachment foot 160, and an intersection point IP4 of imaginary extension lines EL4 passing respectively through the outward long sides of the fourth rectangular-shaped cross section 1414 is positioned at the central axis CA of the rod pipe within the second attachment foot 160. An intersection point IP2 of imaginary extension lines EL2 of the second rectangular-shaped cross section 1412, and an intersection point IP3 of imaginary extension lines EL3 of the third rectangular-shaped cross section 1413 are positioned at the central axis CA of the rod pipe within the second attachment foot 160 between the intersection point IP1 and the intersection point IP4. As shown by the positions of the first to fourth rectangular-shaped cross sections 1411, 1412, 1413 and 1414, the pair of lateral legs 140 arcuately bend such that a spaced distance between the outward long-sided surfaces 144 of the pair of lateral legs 140 increases from the base end of the second attachment foot 160 toward the inflection portion 148.

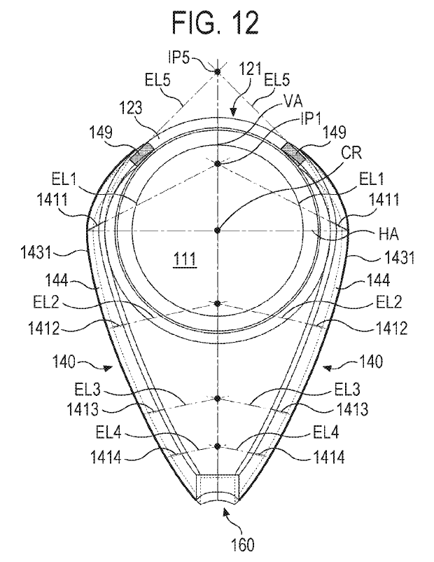

Referring to FIG. 12 that shows a rear view of the fishing line guide, the connection section 149 has a rectangular shape, and an intersection point IP5 of imaginary extension lines EL5 passing through outward long sides of the connection section 149 is positioned at the imaginary vertical axis VA above an upper end of the outer peripheral surface 121 of the ring holding portion. The intersection point IP1 of the first rectangular-shaped cross section 1411 is positioned below an upper end of the passage hole 111 of the guide ring 110 and above the imaginary horizontal axis HA, and is positioned at the imaginary vertical axis VA. Therefore, when rectangular-shaped cross sections orthogonal to the outward long-sided surface 144 are taken between the connection section 149 and the first rectangular-shaped cross section 1411, intersection points of outward long sides of such rectangular-shaped cross sections are positioned at the imaginary vertical axis VA between the intersection point IP5 and the intersection point IP1. Further, the intersection points IP2, IP3, and IP4 of the second to fourth rectangular-shaped cross sections 1412, 1413, and 1414 are positioned at the imaginary vertical axis VA. As such, the pair of lateral legs arcuately bend such that the intersection points of the rectangular-shaped cross sections are positioned at the imaginary vertical axis VA between a position above the upper end of the outer peripheral surface 121 and a position of the upper surface of the second attachment foot 160.

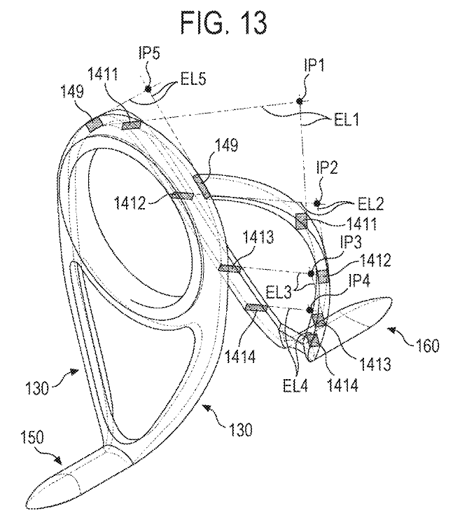

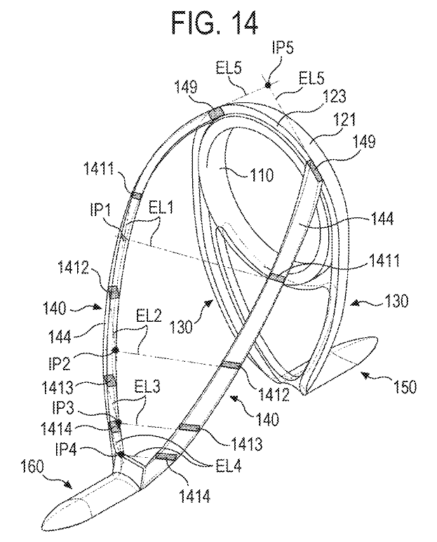

Referring to FIGS. 13 and 14, each lateral leg is connected to the ring holding portion 120 such that the intersection point IP5 of the imaginary extension lines EL5 of the outward long sides of the connection section 149 is positioned above the outer peripheral surface 121 of the ring holding portion. Further, each lateral leg arcuately bends such that the intersection points IP1, IP2, IP3, and IP4 of the imaginary extension lines EL1, EL2, EL3, and EL4 of the first to fourth rectangular-shaped cross sections 1411, 1412, 1413, and 1414 are positioned above each lateral leg. Thus, the intersection points of the rectangular-shaped cross sections of each lateral leg are positioned above each lateral leg between the intersection point IP5 of the connection section 149 and the upper surface of the second attachment foot 160. Accordingly, each lateral leg arcuately bends such that, between the outer peripheral surface 121 and the upper surface of the second attachment foot 160, the outward long-sided surface 144 of each lateral leg faces outward of the fishing line guide and does not face inward of the fishing line guide.

According to one embodiment of the fishing line guide, in the front view and the rear view of the fishing line guide, the lower leg 130 and the lateral leg 140 extend from the ring holding portion such that the front outer contour line of the lower leg 130 and the rear outer contour line of the lateral leg 140 approximately coincide with each other from the upper surface of the first attachment foot or the upper surface of the second attachment foot up to a predetermined height. Therefore, the fishing line can smoothly slide to the outer peripheral surface of the ring holding portion.

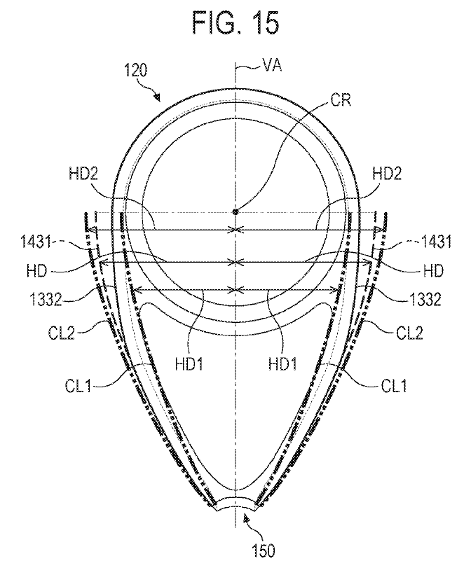

For instance, reference is made together to FIG. 5 which is the rear view of the fishing line guide, and FIG. 15 which is a front view of the fishing line guide while omitting the depiction of the pair of lateral legs and showing only the pair of lower legs. In the front view and the rear view of the fishing line guide, the lower leg and the lateral leg may extend from the ring holding portion such that the front outer contour line 1332 of the lower leg and the rear outer contour line 1431 of the lateral leg (shown by a dashed line in FIG. 15) approximately coincide with each other from the upper surface of the first attachment foot 150 or the upper surface of the second attachment foot 160 within a range of 30% of an overall height of the fishing line guide.

Specifically, a pair of front outer contour lines 1332 may be disposed within a range defined by a pair of first imaginary contour lines CL1 and a pair of second imaginary contour lines CL2, which correspond respectively to a pair of rear outer contour lines 1431. The pair of lower legs 130 extend from the ring holding portion 120 such that the front outer contour line 1332 of each lower leg is positioned between the first imaginary contour line CL1 and the second imaginary contour line CL2 that correspond to the rear outer contour line 1431 of each lateral leg. Regarding the positions of the first and second imaginary contour lines CL1 and CL2, the first imaginary contour line CL1 has a first horizontal spaced distance HD1 between the imaginary vertical axis VA and the first imaginary contour line CL1, and the first horizontal spaced distance HD1 is equal to 80% of a referential horizontal spaced distance HD between the imaginary vertical axis VA and the rear outer contour line 1431. The second imaginary contour line CL2 has a second horizontal spaced distance HD2 between the imaginary vertical axis VA and the second imaginary contour line CL2, and the second horizontal spaced distance HD2 is equal to 105% of the referential horizontal spaced distance HD of the rear outer contour line 1431.

The fishing line guide according to the embodiments of the present disclosure can untangle a line tangle of the fishing line both in the normal attachment shown in FIG. 1 and in the reverse attachment shown in FIG. 2. Therefore, the fishing line guide does not have a restriction on the attachment direction to the rod pipe. Hereinafter, the action of the fishing line guide and the principle of untangling the line tangle are described.

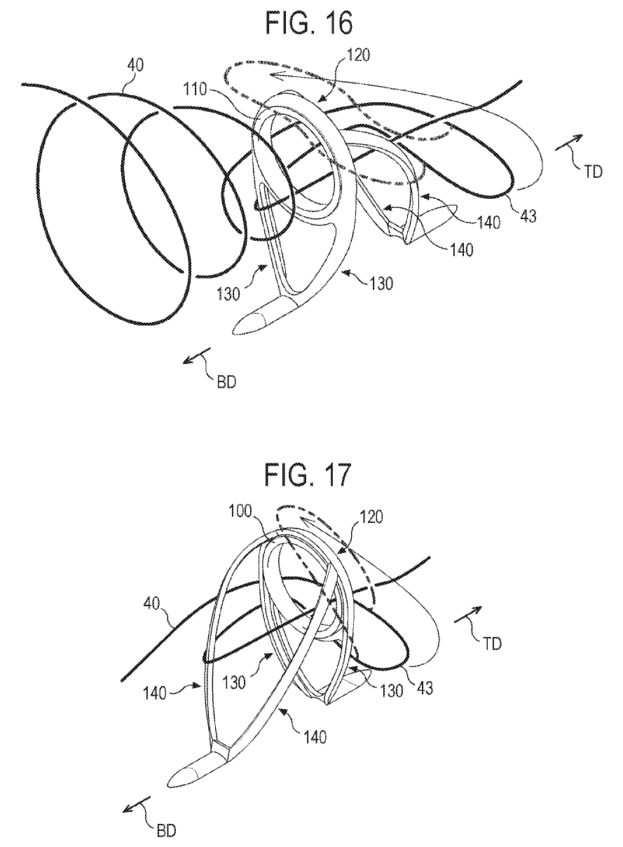

FIG. 16 shows an example where the fishing line guide according to one embodiment is disposed by the normal attachment. Referring to FIG. 16, when the fishing line guide is attached to the rod pipe by the normal attachment, the pair of lateral legs 140 face in the tip direction TD of the fishing rod, and the pair of lower legs 130 are located to be spaced apart from the pair of lateral legs 140 in the butt direction BD. The fishing line guide disposed by the normal attachment as shown in FIG. 16 can allow the fishing line 40 in the spiral shape not to come into contact with the pair of lateral legs 140.

FIG. 17 shows an example where the fishing line guide according to one embodiment is disposed by the reverse attachment. Referring to FIG. 17, when the fishing line guide is attached to the rod pipe by the reverse attachment, the pair of lateral legs 140 face in the butt direction BD directed toward the reel, and the pair of lower legs 130 are located to be spaced apart from the pair of lateral legs 140 in the tip direction TD.

The speed of the cast fishing rig may decrease, but the speed of the fishing line reeled out from the reel may not decrease. Therefore, referring to FIGS. 16 and 17, a portion of the fishing line before passing through the guide ring 110 or a portion of the fishing line that has passed through the guide ring 110 can create a loop portion 43 that has a loop shape. Due to a crosswind or a movement of the fishing rod under such a situation, the loop portion 43 is moved to the ring holding portion 120, and the fishing line 40 can become tangled by being wound around the guide ring 110 and the ring holding portion 120. Further, in a state where the fishing line becomes tangled with the guide ring and the ring holding portion, a portion of the fishing line 40 can be in contact with the lower leg and the lateral leg of the fishing line guide. Hereinafter, a portion of the fishing line that becomes tangled with the guide ring and the ring holding portion is referred to as a tangled portion, and a portion of the fishing line that is in contact with the lower leg or the lateral leg is referred to as a contacted portion. In the examples of the normal attachment shown in FIG. 16 and the reverse attachment shown in FIG. 17, the fishing line guide can easily untangle various types of line tangles of the fishing line, and can smoothly guide the fishing line.

Reference is made to FIGS. 18 to 22 showing an example where the line tangle of the fishing line is untangled when the fishing line guide is disposed on the rod pipe by the normal attachment like FIG. 16.

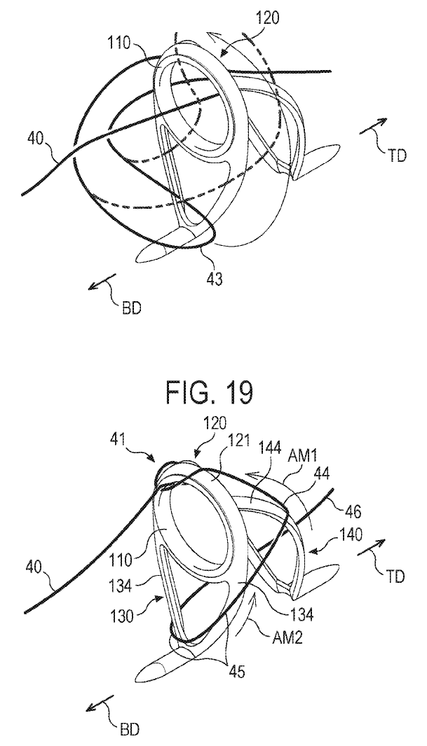

Referring to FIG. 18, a portion of the fishing line that has passed through the guide ring 110 (shown by a solid line) creates the loop portion 43. The loop portion 43 can pass across a portion of the fishing line before passing through the guide ring 110, and then rise along the ring holding portion 120, and FIG. 18 shows the shape of the rising loop portion by a dashed line. Due to this, the line tangle of the fishing line shown in FIG. 19 can occur in the fishing line guide. Referring to FIG. 19, in the state where the line tangle of the fishing line occurs, the aforementioned loop portion forms a tangled portion 41 wound around the guide ring 110 and the ring holding portion 120. Further, in the state where the line tangle of the fishing line occurs, the fishing line is in contact with the lateral leg 140 at a contacted portion 44, and is in contact with the lower leg 130 at another contacted portion 45. A tension force generated due to casting of the fishing rig continues to act on the fishing line 40 in the tip direction TD, and a portion 46 of the fishing line is moved in the tip direction TD of the fishing rod due to the aforesaid tension force. Due to the movement of the fishing line caused by the tension force and due to the shape characteristics of the fishing line guide, the contacted portion 44 and the contacted portion 45 are moved to the outer peripheral surface 121 of the ring holding portion, and the tangled portion 41 is untangled thereby.

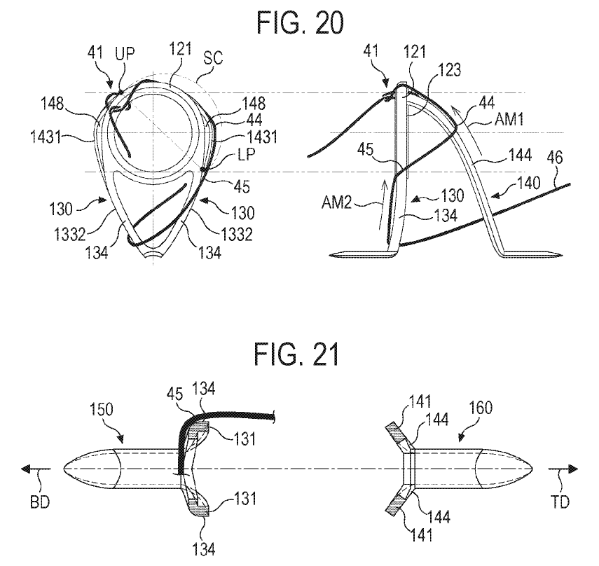

Referring to FIGS. 19 and 20, the contacted portion 44 in contact with the lateral leg is moved to the outer peripheral surface 121 of the ring holding portion along the outward long-sided surface 144 of the lateral leg in a direction of an arrow mark AM1. Since the outward long-sided surface 144 faces outward of the fishing line guide without twisting, the contacted portion 44 slides to the outer peripheral surface 121 along the outward long-sided surface 144 in the state of being in contact with only the outward long-sided surface 144. Since the lateral leg 140 has the above-described rear outer contour line 1431, the contacted portion 44 passes the inflection portion 148 of the lateral leg and slides to the outer peripheral surface 121. The ring holding portion 120 and a portion of the lateral leg 140 including the inflection portion 148 are positioned inside the imaginary semicircle SC between the upper intersection point UP and the lateral intersection point LP. Therefore, the contacted portion 44 and a portion of the fishing line between the contacted portion 44 and the contacted portion 45 slide to the outer peripheral surface 121 of the ring holding portion without being caught on the annular end surface 123 of the ring holding portion between the lower leg 130 and the ring holding portion 120 or between the lower leg 130 and the lateral leg 140.

Referring to FIGS. 19 and 20, the contacted portion 45 in contact with the lower leg is moved to the outer peripheral surface 121 of the ring holding portion along the bent outward surface 134 of the lower leg in a direction of an arrow mark AM2. Since the lower leg 130 has the front outer contour line 1332 that is tangent to the middle of the outer peripheral surface 121 of the ring holding portion, the contacted portion 45 passes the bent outward surface 134 of the lower leg and smoothly slides to the upper end of the outer peripheral surface 121. As shown in FIG. 21, the bent outward surface 134 arcuately bends and does not form an angulated surface. Therefore, the contacted portion 45 smoothly slides to the outer peripheral surface of the ring holding portion along the bent outward surface 134 without being restricted by the bent outward surface 134.

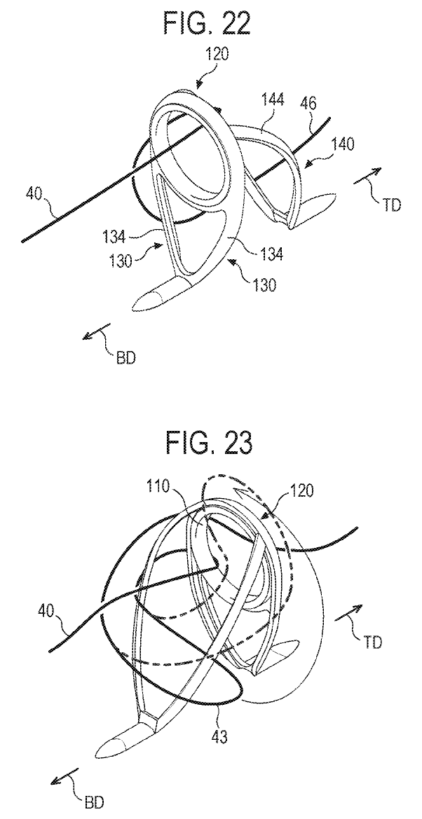

Referring to FIG. 22, the contacted portions of the fishing line are moved as described above, and the tangled portion shown in FIG. 19 is untangled. As shown in FIGS. 19 to 22, the fishing line guide according to one embodiment is disposed on the rod pipe by the normal attachment, and can easily untangle the line tangle of the fishing line.

Reference is made to FIGS. 23 to 28 showing an example where a line tangle of the fishing line is untangled when the fishing line guide is disposed on the rod pipe by the reverse attachment like FIG. 17.

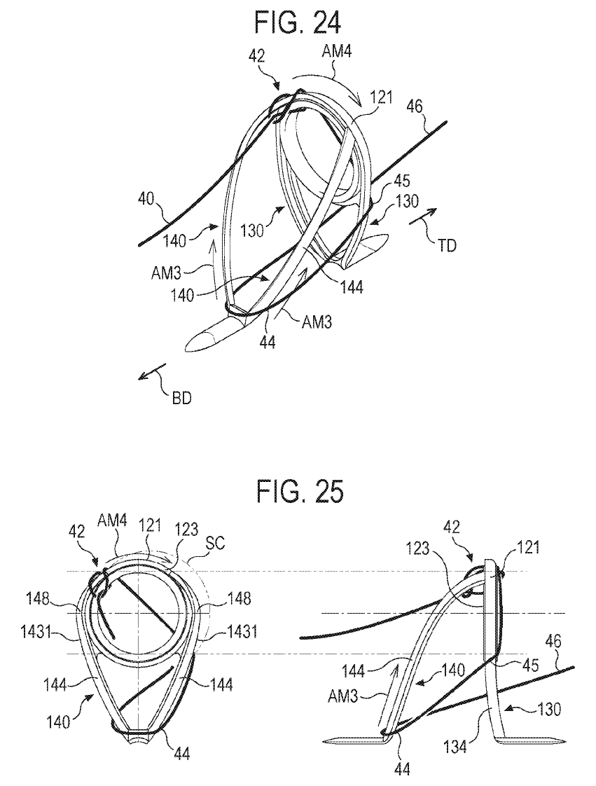

Referring to FIG. 23, the loop portion 43, which is formed by a portion of the fishing line that has passed through the guide ring 110 (shown by a solid line), can rise along the ring holding portion 120, and the shape of the rising loop portion is shown by a dashed line. Due to this, the line tangle of the fishing line shown in FIG. 24 can occur in the fishing line guide. Referring to FIG. 24, in the state where the line tangle of the fishing line occurs, the aforesaid loop portion forms a tangled portion 42 that is wound around the guide ring 110 and the ring holding portion 120 at the upper end of the lateral leg 140. Further, the fishing line is in contact with the lateral leg 140 at the contacted portion 44, and is in contact with the lower leg 130 at the contacted portion 45. As the portion 46 of the fishing line is moved in the tip direction TD by the tension force generated due to casting of the fishing rig, the contacted portion 44 and the contacted portion 45 are moved to the outer peripheral surface 121 of the ring holding portion, the tangled portion 42 is moved, and the tangled portion 42 is untangled.

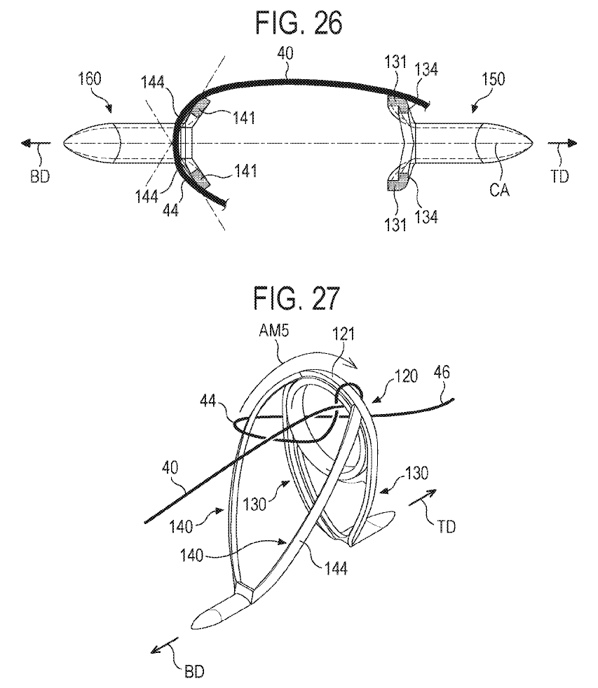

Referring to FIGS. 25 and 26, the contacted portion 44 in contact with the lateral leg is moved to the outer peripheral surface 121 of the ring holding portion along the outward long-sided surface 144 in a direction of an arrow mark AM3. The outward long-sided surface 144 faces outward of the fishing line guide with hardly any twisting, and forms the rear outer contour line 1431 of the lateral leg. Further, as shown in FIG. 26, the outward long-sided surface 144 is inclined at an acute angle with respect to the central axis CA of the rod pipe. Therefore, the contacted portion 44 slides to the outer peripheral surface 121 without being caught on the outward long-sided surface 144. The contacted portion 45 in contact with the lower leg slides to the outer peripheral surface 121 along the bent outward surface 134 of the lower leg. Since the ring holding portion 120 and a portion of the lateral leg 140 including the inflection portion 148 are positioned inside the imaginary semicircle SC, the tangled portion 42 is moved in a direction of an arrow mark AM4 without being restricted between the lateral leg 140 and the ring holding portion 120, together with the movement of the contacted portions 44 and 45.

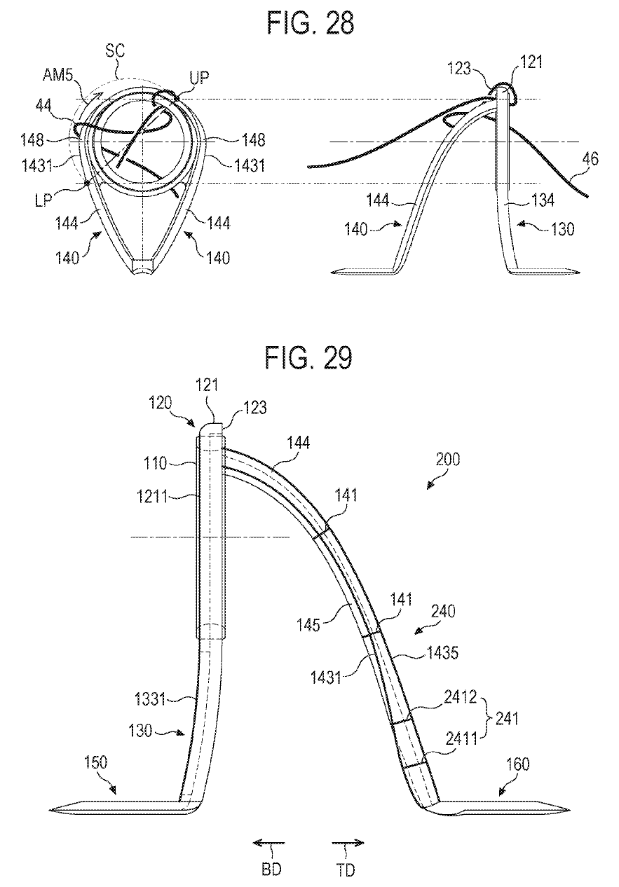

After the contacted portions 44 and 45 are moved as described above, the fishing line becomes tangled with the fishing line guide in a state shown in FIG. 27. Referring to FIGS. 27 and 28, the tangled portion shown in FIG. 24 is untangled to some extent, and the contacted portion 44 shown in FIG. 24 passes the inflection portion 148 of the lateral leg and is positioned between the inflection portion 148 and the ring holding portion 120. As shown in FIG. 28, since the ring holding portion 120 and an upper portion of the lateral leg 140 are positioned inside the imaginary semicircle SC between the upper intersection point UP and the lateral intersection point LP, the contacted portion 44 passes the upper end of the outer peripheral surface 121 and easily moves in a direction of an arrow mark AM5. Therefore, the tangled portion shown in FIG. 24 can be untangled completely. The fishing line guide according to one embodiment can easily untangle the line tangle of the fishing line even in the case of being disposed on the rod pipe by the reverse attachment as shown in FIGS. 23 to 28.

Reference is made to FIGS. 29 to 32 that show a modified embodiment of the foregoing embodiment. The fishing line guide 200 shown in FIGS. 29 to 33 includes a pair of lateral legs 240 that are modified in comparison with the lateral legs of the fishing line guide according to the foregoing embodiment.

Each of the lateral legs 240 has two types of cross sections. The lateral leg 240 has a bent band-shaped cross section 241 at the vicinity of the base end of the second attachment foot 160. Further, the lateral leg 240 has the above-described rectangular-shaped cross section 141 between the bent band-shaped cross section 241 and the annular end surface 123 of the ring holding portion. The bent band-shaped cross section 241 is formed in a shape of a bent band when taken in the traversing direction orthogonal to the outermost surface of the lateral leg. Therefore, the lateral leg 240 is formed such that the cross section thereof gradually changes from the bent band-shaped cross section 241 to the rectangular-shaped cross section 141 from the second attachment foot 160 toward the annular end surface 123 of the ring holding portion.

The lateral leg 240 may have the bent band-shaped cross section 241 from the base end of the second attachment foot 160 along the lateral leg within a predetermined range. The bent band-shaped cross section 241 may take a shape ranging from a shape of an angularly bent band to a shape of a band that is hardly bent. For example, the bent band-shaped cross section 2411 may take a shape of a band that is bent angularly at 90 degrees, and the bent band-shaped cross section 2412 may take a shape of a band that is bent angularly at 45 degrees. In the lateral leg 240, the highest position of the bent band-shaped cross section may correspond to a height of a lower end of the ring holding portion 120 (see FIG. 29). At the highest position of the bent band-shaped cross section, the lateral leg 240 has the rectangular-shaped cross section 141. Since the lateral leg 240 has the bent band-shaped cross section between the base end of the second attachment foot 160 and the predetermined height, the lateral leg 240 can have a wider cross section, and the fishing line guide 200 can have improved strength at the lateral leg.

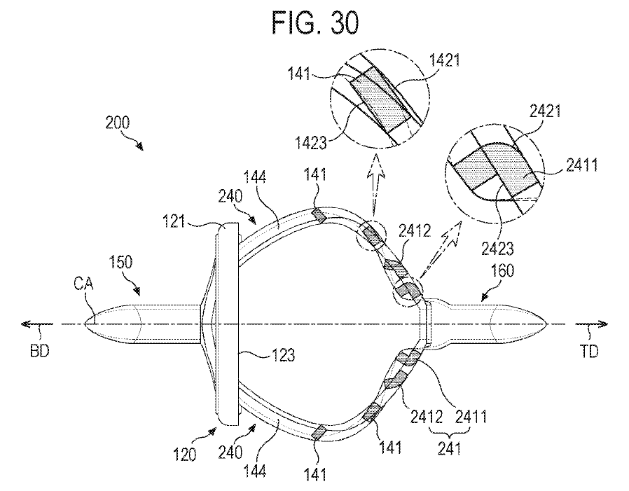

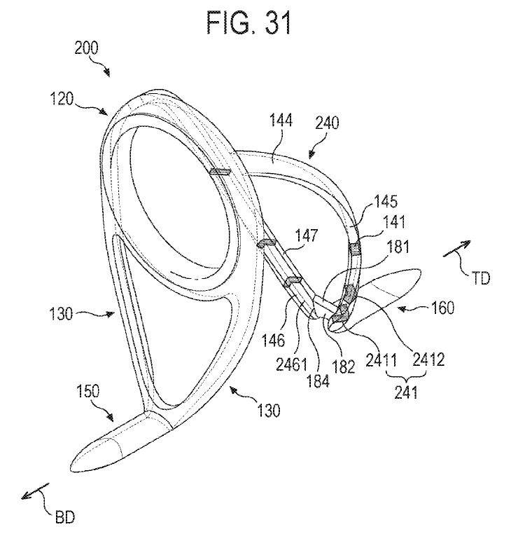

Referring to FIGS. 29 and 30, the lateral leg 240 has the upper contour line 1435 that is formed only by the outward long-sided surface 144. The outward long-sided surface 144 of the lateral leg 240 forms the above-described rear outer contour line, and is continuously connected to the outer peripheral surface 121 of the ring holding portion. The outward long-sided surface 144 of the lateral leg 240 includes an arcuately bent outward long side 2421 of the bent band- shaped cross section at the region of the bent band-shaped cross section, and includes the above-described outward long side 1421 of the rectangular-shaped cross section at the region of the rectangular-shaped cross section. The outward long-sided surface 144 of the lateral leg 240 can make contact with the fishing line between the second attachment foot and the lower end of the ring holding portion with a surface area wider than the outward long-sided surface of the foregoing embodiment. Only the outward long-sided surface 144 is connected to the upper surface 162 of the second attachment foot 160.

Referring to FIG. 30, the cross section of the lateral leg 240 may take a shape ranging from a shape of the bent band-shaped cross section 2411 that is bent angularly at 90 degrees to a shape of a band that is hardly bent angularly (e.g., a shape similar to the rectangular-shaped cross section 141). The rectangular-shaped cross section 141 of the lateral leg 240 is positioned above the bent band-shaped cross section 241. The intersection point of the imaginary extension lines passing through the outward long sides of the rectangular-shaped cross section 141 is positioned at the central axis CA of the rod pipe within the second attachment foot 160.

Referring to FIGS. 30 and 31, the inward long-sided surface 146 of the lateral leg 240 is connected to the inward end surface 182 of the bridging portion 180. The inward long-sided surface 146 includes an angularly bent inward long side 2423 of the bent band-shaped cross section at the region of the bent band-shaped cross section, and includes the above-described inward long side 1423 of the rectangular-shaped cross section at the region of the rectangular-shaped cross section. The inward long-sided surface 146 has an angularly bent edge 2461 at the region of the bent band-shaped cross section. The angularly bent edge 2461 corresponds to an angularly bent point of the inward long side 2423 of the bent band-shaped cross section. The angularly bent edge 2461 may be connected to the above-described lower end edge of the second attachment foot 160. The outward short-sided surface 145 of the lateral leg 240 is connected to the lower end of the second attachment foot 160, and the inward short-sided surface 147 of the lateral leg 240 is connected to the upward end surface 181 of the bridging portion 180.

Reference is made to FIGS. 33 to 38 showing another embodiment of the fishing line guide.

When compared to the fishing line guide according to the foregoing embodiment, a fishing line guide 300 shown in FIGS. 33 to 38 includes only one attachment foot 350, and therefore can be used as a fishing line guide having a single attachment foot. The fishing line guide 300 shown in FIGS. 33 to 38 may be manufactured by press working from a blank of a metallic sheet that is formed not to have the lateral legs and the second attachment foot of the fishing line guide according to the foregoing embodiment. The fishing line guide 300 has a same configuration as the configuration of the fishing line guide according to the foregoing embodiment except the above-described lateral legs and second attachment foot. The configuration and structure of the fishing line guide 300 can be understood from the configuration and structure of the fishing line guide according to the foregoing embodiment.

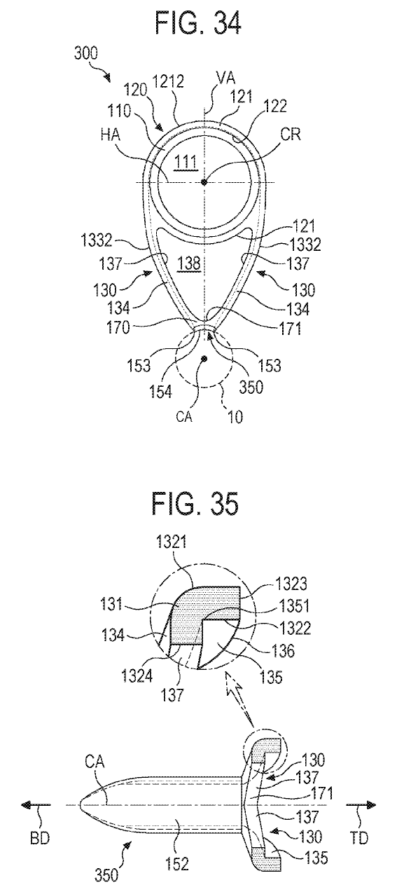

Referring to FIGS. 33 and 34, the fishing line guide 300 includes the guide ring 110, the ring holding portion 120, the pair of lower legs 130, the attachment foot 350 and the bridging portion 170. The attachment foot 350 is the first attachment foot of the fishing line guide of the foregoing embodiment. Referring to FIG. 33, similarly to the normal attachment of the fishing line guide of the foregoing embodiment, the fishing line guide 300 is disposed on the rod pipe to face in the butt direction BD in which the attachment foot 350 faces the reel. In the front view (see FIG. 34) of the fishing line guide, each of the pair of lower legs 130 has the front outer contour line 1332 that is tangent to the middle of the outer peripheral surface 121 of the ring holding portion.

Referring to FIG. 35, each of the pair of lower legs 130 has the bent-shaped cross section 131 taken in the sectioning direction parallel to the central axis CA of the rod pipe. In the top view of the fishing line guide or the cross-sectional view of the lower leg taken in the sectioning direction, the bent-shaped cross section 131 may be formed in a shape of a bent band. The aforesaid bent-band shape bends to be concave with respect to the central axis CA of the rod pipe. The bent-shaped cross section 131 may be defined by the outward side 1321, the inward side 1322, the outer end side 1323, and the inner end side 1324. In the top view of the fishing line guide or the cross-sectional view of the lower leg, the outward side 1321 faces in the outward direction away from the central axis CA of the rod pipe. The inward side 1322 is located opposite to the outward side 1321, and faces in the inward direction toward the central axis CA of the rod pipe in the top view of the fishing line guide or the cross-sectional view of the lower leg. The outward side 1321 has an arcuately bent shape, and the inward side 1322 has an angularly bent shape. The outer end side 1323 faces in the orientation direction of the annular end surface, and the inner end side 1324 faces one of the pair of lower legs.

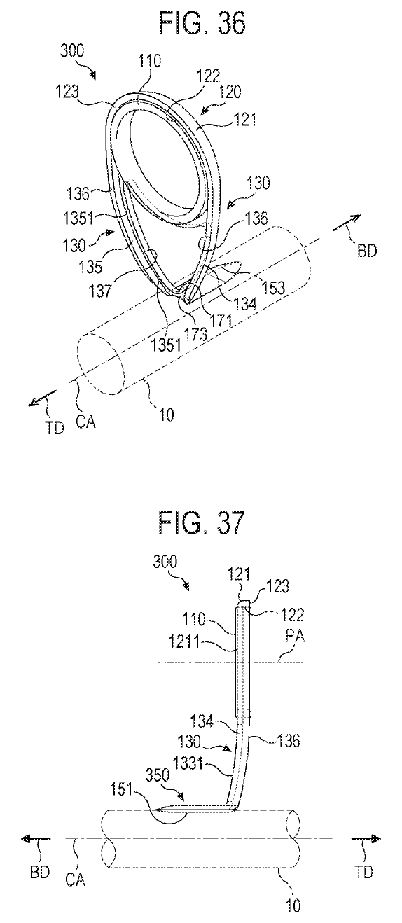

Referring to FIGS. 35 and 36, each lower leg includes the bent outward surface 134 including the outward side 1321, the bent inward surface 135 including the inward side 1322, the outer end surface 136 including the outer end side 1323, and the inner end surface 137 including the inner end side 1324. The bent outward surface 134 is arcuately bent by the outward side 1321. The bent outward surface 134 forms the aforementioned front outer contour line. The bent outward surface 134 is continuously connected to the outer peripheral surface 121 of the ring holding portion, and is connected to the upper surface 152 of the attachment foot 350. When a line tangle of the fishing line occurs, the bent outward surface 134 causes the fishing line to slide to the outer peripheral surface 121 of the ring holding portion, and the fishing line is moved to the outer peripheral surface 121 along the bent outward surface 134. The bent inward surface 135 is angularly bent by the inward side 1322, and is connected to the inner peripheral surface 122 of the ring holding portion. The outer end surface 136 and the inner end surface 137 are formed as a flat surface. The outer end surface 136 is continuously connected to the annular end surface 123 of the ring holding portion, and is continuously connected to the lower end of the attachment foot 350. The inner end surface 137 is continuously connected to the lower portion of the outer peripheral surface 121 of the ring holding portion.

Referring to FIG. 37, the pair of lower legs 130 extend from the ring holding portion 120 such that the ring holding portion 120 and the attachment foot 350 are disposed at a right angle. The side outer contour line 1211 of the outer peripheral surface 121 is perpendicular with respect to the lower end contour line 151 of the attachment foot 350, and the pair of lower legs 130 are inclined in the opposite direction (the butt direction) of the orientation direction of the annular end surface with respect to the side outer contour line 1211 of the outer peripheral surface. Therefore, the side outer contour line 1331 of the lower leg 130 is formed to be inclined from the side outer contour line 1211 of the outer peripheral surface 121 in the butt direction, and the fishing line can be easily moved to the outer peripheral surface 121.

Referring to FIGS. 33, 34, and 36, the inner end surface 137 of each lower leg is continuously connected to the upward end surface 171 of the bridging portion 170. The bent inward surface 135 of each lower leg is continuously connected to the inward end surface 173 of the bridging portion. The outer peripheral surface 121 of the ring holding portion, the inner end surface 137 of each lower leg, and the upward end surface 171 of the bridging portion form the opening 138 between the pair of lower legs.

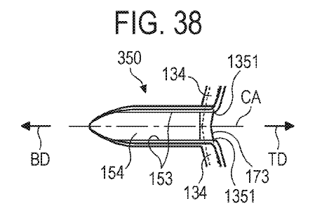

Referring to FIGS. 36 and 38, the attachment foot 350 includes the pair of lower end edges 153 and the concave lower surface 154. Each of the pair of lower end edges 153 is continuously connected to the angularly bent edge 1351 of each of the bent inward surfaces 135. The concave lower surface 154 is continuously connected to the inward end surface 173 of the bridging portion 170. The lower end edge 153 and the angularly bent edge 1351 are formed by the press line of the fishing line guide manufactured by press working. Since the lower end edge 153 and the angularly bent edge 1351 are connected continuously, the fishing line guide can have improved strength between the lower legs and the attachment foot.

The technical idea of the present disclosure has been described heretofore with reference to some embodiments and examples shown in the accompanying drawings. However, it is to be understood that various substitutions, modifications, and alterations may be made without departing from the technical idea and scope of the present disclosure that can be understood by those of ordinary skill in the technical field to which the present disclosure pertains. Further, it is to be understood that such substitutions, modifications, and alterations fall within the scope of the appended claims.

What is claimed is:

1. A fishing line guide attached to a rod pipe of a fishing rod, comprising:
a guide ring configured such that a fishing line passes through the guide ring;
a ring holding portion formed in an annular shape and having an outer peripheral surface, an inner peripheral surface coupled to the guide ring, and an annular end surface formed between the outer peripheral surface and the inner peripheral surface and oriented in a tip direction or a butt direction of the fishing rod;
a pair of lower legs extending downward from the ring holding portion to approach each other and having a bent-shaped cross section that is formed in a shape of a bent band when taken in a sectioning direction parallel to a central axis of the rod pipe;
a pair of lateral legs connected to the ring holding portion above a position where the pair of lower legs are connected to the ring holding portion, extending from the ring holding portion downward and in an orientation direction of the annular end surface, arcuately bending to approach each other, and having a rectangular-shaped cross section that is formed in a rectangular shape when taken in a traversing direction orthogonal to an outermost surface;
a first attachment foot extending from the pair of lower legs; and
a second attachment foot extending from the pair of lateral legs,
wherein, in a front view in which the fishing line guide is viewed in an opposite direction of the orientation direction of the annular end surface, each of the pair of lower legs has a front outer contour line that is tangent to a middle of the outer peripheral surface of the ring holding portion,
wherein, in a rear view in which the fishing line guide is viewed in the orientation direction of the annular end surface, each of the pair of lateral legs has a rear outer contour line that arcuately bends to have an inflection point positioned outside the outer peripheral surface of the ring holding portion and is connected to the outer peripheral surface, and
wherein, in a top view of the fishing line guide, the pair of lateral legs arcuately bend such that an intersection point of a pair of imaginary extension lines respectively passing through outward long sides of the rectangular-shaped cross section of the pair of lateral legs is positioned within the second attachment foot.

2. The fishing line guide of claim 1, wherein each of the pair of lower legs includes a bent outward surface that is arcuately bent by an arcuately bent outward side of the bent-shaped cross section,
wherein the bent outward surface forms the front outer contour line and is continuously connected to the outer peripheral surface to cause the fishing line to move to the outer peripheral surface of the ring holding portion,
wherein each of the lateral legs includes an outward long-sided surface that includes the outward long side of the rectangular-shaped cross section, and
wherein the outward long-sided surface forms the rear outer contour line and is continuously connected to the outer peripheral surface to cause the fishing line to move to the outer peripheral surface of the ring holding portion.

3. The fishing line guide of claim 2, wherein, in the rear view of the fishing line guide, the pair of lateral legs arcuately bend such that the intersection point is positioned between a position above an upper end of the outer peripheral surface and a position of an upper surface of the second attachment foot at an imaginary vertical axis passing through a center of the ring holding portion, and
wherein, in a side view of the fishing line guide, each of the pair of lateral legs arcuately bends to have an upper contour line formed only by the outward long-sided surface.

4. The fishing line guide of claim 1, wherein, in a side view of the fishing line guide, the pair of lower legs extend from the ring holding portion such that the outer peripheral surface has a side outer contour line perpendicular with respect to a lower end contour line of the first attachment foot, and that the pair of lower legs are inclined in the opposite direction of the orientation direction of the annular end surface with respect to the side outer contour line.

5. The fishing line guide of claim 1, wherein the first attachment foot includes a pair of lower end edges formed in a longitudinal direction of the first attachment foot, and a concave lower surface formed between the pair of lower end edges,
wherein each of the pair of lower legs includes a bent inward surface that is angularly bent by an angularly bent inward side of the bent-shaped cross section, and
wherein the bent inward surface has an angularly bent edge that is continuously connected to one of the pair of lower end edges.

6. The fishing line guide of claim 1, further comprising a bridging portion that is formed integrally with the pair of lateral legs and the second attachment foot at lower ends of the pair of lateral legs and a base end of the second attachment foot,
wherein the second attachment foot includes a pair of lower end edges formed in a longitudinal direction of the second attachment foot, and a concave lower surface formed between the pair of lower end edges, and
wherein the bridging portion has a pair of angularly bent edges that become boundaries between the pair of lateral legs and the bridging portion and are continuously connected to the pair of lower end edges, respectively.

7. The fishing line guide of claim 1, wherein, in the rear view of the fishing line guide, the pair of lateral legs are connected to the ring holding portion such that the ring holding portion is positioned inside an imaginary semicircle, and
wherein one end of the imaginary semicircle is positioned at an upper intersection point between one of the pair of the lateral legs and the annular end surface, and an opposite end of the imaginary semicircle is positioned at a lateral intersection point between the other of the pair of lateral legs and an imaginary horizontal line passing through a lower end of a passage hole of the guide ring.

8. The fishing line guide of claim 1, wherein, in the front view and the rear view of the fishing line guide, the pair of lower legs extend from the ring holding portion such that the front outer contour line is positioned between a first imaginary contour line and a second imaginary contour line that correspond to the rear outer contour line,
wherein the first imaginary contour line has a first horizontal spaced distance between the first imaginary contour line and an imaginary vertical axis passing through a center of the ring holding portion, and the second imaginary contour line has a second horizontal spaced distance between the second imaginary contour line and the imaginary vertical axis, and
wherein the first horizontal spaced distance is equal to 80% of a referential horizontal spaced distance between the imaginary vertical axis and the rear outer contour line, and the second horizontal spaced distance is equal to 105% of the referential horizontal spaced distance.

9. The fishing line guide of claim 1, wherein each of the pair of lateral legs has a bent band-shaped cross section that is formed in a shape of a bent band when taken in the traversing direction at the vicinity of the second attachment foot, and the rectangular-shaped cross section between the bent band-shaped cross section and the ring holding portion, and
wherein each of the pair of lateral legs is formed such that a cross section of each of the pair of lateral legs gradually changes from the bent band-shaped cross section to the rectangular-shaped cross section from the second attachment foot toward the annular end surface of the ring holding portion.

10. A fishing rod comprising:
a rod pipe; and
the fishing line guide of claim 1 attached to the rod pipe.

11. A fishing line guide attached to a rod pipe of a fishing rod, comprising:
a guide ring configured such that a fishing line passes through the guide ring;
a ring holding portion formed in an annular shape and having an outer peripheral surface, an inner peripheral surface coupled to the guide ring, and an annular end surface formed between the outer peripheral surface and the inner peripheral surface and oriented in a tip direction of the fishing rod;
a pair of lower legs extending downward from the ring holding portion to approach each other and having a bent-shaped cross section that is formed in a shape of a bent band when taken in a sectioning direction parallel to a central axis of the rod pipe;
an attachment foot extending from the pair of lower legs; and
a bridging portion formed integrally with the pair of lower legs and the attachment foot at lower ends of the pair of lower legs and a base end of the attachment foot,
wherein, in a front view in which the fishing line guide is viewed in an opposite direction of an orientation direction of the annular end surface, each of the pair of lower legs has a front outer contour line that is tangent to a middle of the outer peripheral surface,
wherein each of the pair of lower legs includes a bent outward surface, which is arcuately bent by an arcuately bent outward side of the bent-shaped cross section, forms the front outer contour line, and is continuously connected to the outer peripheral surface to cause the fishing line to move to the outer peripheral surface, and
wherein, in a side view of the fishing line guide, the pair of lower legs extend from the ring holding portion such that the outer peripheral surface has a side outer contour line perpendicular with respect to a lower end contour line of the attachment foot, and that the pair of lower legs are inclined in the opposite direction of the orientation direction of the annular end surface with respect to the side outer contour line.

12. A fishing rod comprising:
a rod pipe; and
the fishing line guide of claim 11 attached to the rod pipe.
